(19) United States
(12) Patent Application Publication
(10) Pub. No.: US 2023/0155733 A1
(43) Pub. Date: May 18, 2023

(54) DEVICE AND METHOD FOR TRANSMITTING RESPONSE PACKET

(71) Applicant: SAMSUNG ELECTRONICS CO., LTD., Suwon-si (KR)

(72) Inventors: Gupil CHEONG, Suwon-si (KR); Sanghyeok KIM, Suwon-si (KR); Hyungseoung YOO, Suwon-si (KR); Juyeon JIN, Suwon-si (KR); Doosuk KANG, Suwon-si (KR)

(21) Appl. No.: 17/988,635

(22) Filed: Nov. 16, 2022

Related U.S. Application Data
(63) Continuation of application No. PCT/KR2022/017270, filed on Nov. 4, 2022.

(30) Foreign Application Priority Data
Nov. 17, 2021 (KR) 10-2021-0158246

(51) Int. Cl. H04L 1/00; H04L 5/00

(52) U.S. Cl. CPC H04L 1/0091; H04L 1/0079; H04L 5/0055

(57) ABSTRACT

A first electronic device may share information about a received packet with a second electronic device to obtain first information indicating whether the first electronic device and the second electronic device each receive a data packet from the third electronic device during a first time period, in case that the first information indicates that the first electronic device and the second electronic device each fail to receive the data packet during the first time period, transmit a first response packet indicating a negative acknowledgment (NACK) to the third electronic device, and share the information about the received packet with the second electronic device to obtain second information indicating whether the first electronic device and the second electronic device each receive the data packet retransmitted from the third electronic device during a second time period after the first time period.

### CROSS-REFERENCE TO RELATED APPLICATION(S)

This application is a continuation application, claiming priority under § 365(c), of an International application No. PCT/KR2022/017270, filed on Nov. 4, 2022, which is based on and claims the benefit of a Korean patent application number 10-2021-0158246, filed on Nov. 17, 2021, in the Korean Intellectual Property Office, the disclosure of each of which is incorporated by reference herein in its entirety.

### TECHNICAL FIELD

The disclosure relates to a device and method for transmitting a response packet.

### BACKGROUND ART

Bluetooth communication technology may support a short-range wireless communication that enables electronic devices to be connected to each other for exchanging data or information. The Bluetooth communication technology may include Bluetooth legacy (or classic) communication technology or Bluetooth low energy (BLE) communication technology.

In communication using Bluetooth legacy communication technology, a first electronic device may transmit a data packet to a second electronic device, and the second electronic device may transmit a response packet to the first electronic device to inform whether the data packet has been successfully received. The header of the response packet may include a bit, e.g., an ARQN bit, to indicate whether the data packet has been successfully received. The second electronic device may set the ARQN bit to a value (e.g., 1) indicating an acknowledgment (ACK) when the data packet is successfully received and set the ARQN bit to a value (e.g., 0) indicating a negative acknowledgment (NACK) when the data packet is not successfully received. When the second electronic device does not receive the data packet at all due to a physical obstacle or a surrounding channel environment, the second electronic device may not be able to transmit the response packet.

Upon receiving the response packet from the second electronic device, the first electronic device may determine whether the second electronic device has successfully received the data packet based on the ARQN bit included in the header of the response packet. The first electronic device may determine whether to retransmit the data packet or to transmit the next data packet based on whether the second electronic device has successfully received the data packet. If the first electronic device does not receive the response packet from the second electronic device within a set time, the first electronic device may determine that the second electronic device has not successfully received the data packet and may retransmit the data packet.

In communication using BLE communication technology, the first electronic device may transmit a data packet to the second electronic device. The header of the data packet transmitted to the second electronic device may include a next expected sequence number (NESN) to be received by the second electronic device.

The second electronic device may transmit a response packet to inform the first electronic device of whether the data packet has been successfully received. The header of the response packet may include a sequence number (SN).

The first electronic device may determine whether the second electronic device has successfully received the data packet based on the NESN and the SN. For example, when the SN included in the header of the response packet is the same as the NESN included in the header of the transmitted data packet, the first electronic device may determine that the second electronic device has successfully received the data packet. Alternatively, when the SN included in the header of the response packet is different from the NESN included in the header of the transmitted data packet, the first electronic device may determine that the second electronic device has not successfully received the data packet.

In a Bluetooth communication environment, two or more electronic devices operating as one electronic device, such as true wireless stereo (TWS) devices, may be used. For example, when two electronic devices are used in a Bluetooth communication environment, the first electronic device may create a communication link for direct communication with an external electronic device, such as a smart phone, and the second electronic device may monitor the communication link created by the first electronic device. The second electronic device may receive, for example, a data packet transmitted from an external electronic device based on the monitoring operation of the communication link.

The response packet to the data packet may be transmitted only by the first electronic device among the two electronic devices. Upon successfully receiving the data packet, the first electronic device may transmit a response packet indicating ACK (hereinafter referred to as an ‘ACK packet’) to the external electronic device. After transmitting the ACK packet to the external electronic device, the first electronic device may identify whether the second electronic device has successfully received the data packet. For example, the first electronic device may transmit a packet inquiring whether the second electronic device has successfully received the data packet to the second electronic device and may receive a packet indicating whether the data packet has been successfully received from the second electronic device.

The first electronic device has an obligation to transfer the data packet to the second electronic device when the second electronic device does not successfully receive the data packet. However, the first electronic device cannot receive a new data packet from the external electronic device while transferring the data packet to the second electronic device. Further, since the external electronic device does not know that the second electronic device has not successfully received the data packet, the external electronic device has no other choice but to transmit a new data packet to the first electronic device based on the ACK packet received from the first electronic device. Accordingly, since the external electronic device transmits a new data packet in a situation in which the first electronic device cannot receive the new data packet, unnecessary resource waste may occur.

In another example of transmitting the response packet to the data packet, the ACK packet may be transmitted only when both of the electronic devices successfully receive the data packet transmitted by the external electronic device. For example, if at least one of the two electronic devices fails to receive the data packet, the ACK packet cannot be transmitted, and a response packet indicating NACK (hereinafter, referred to as a ‘NACK packet’) may be transmitted to the external electronic device.

Whether the first electronic device receives the data packet and whether the second electronic device receives the data packet may be identified by the first electronic device. The first electronic device may receive a response packet from the second electronic device and may identify whether the second electronic device has received the data packet based on the received response packet.

The first electronic device may transmit an ACK packet or a NACK packet to the external electronic device based on whether the first electronic device has received the data packet and whether the second electronic device has received the data packet. When the first electronic device receives the data packet and the second electronic device does not receive the data packet, the first electronic device may transfer the data packet to the second electronic device. After transferring the data packet, the first electronic device may identify whether the second electronic device has received the data packet and may retransfer the data packet to the second electronic device based on the result of the identification.

As such, when only one of the two electronic devices successfully receives the data packet at the same time, transmission of an ACK packet is impossible so that many operations as described above may need to be performed between the first electronic device and the second electronic device. Accordingly, significant resource waste until an ACK packet is transmitted is inevitable.

### Technical Solution

According to an embodiment, there may be provided a device and method for transmitting a response packet, which allows for efficient communication between electronic devices by reducing latency and preventing resource waste.

According to an embodiment, a first electronic device may comprise a memory, a communication module configured to perform communication with a second electronic device and/or a third electronic device, and at least one processor operatively connected with the memory and the communication module.

According to an embodiment, the memory may store instructions configured to, when executed, cause the first electronic device to share information about a received packet with the second electronic device to obtain first information indicating whether the first electronic device and the second electronic device each receive a data packet from the third electronic device during a first time period.

According to an embodiment, the instructions are configured to, when executed, cause the first electronic device to transmit a first response packet indicating a negative acknowledgment (NACK) to the third electronic device in case that the first information indicates that the first electronic device and the second electronic device each fail to receive the data packet during the first time period.

According to an embodiment, the instructions are configured to, when executed, cause the first electronic device to share the information about the received packet with the second electronic device to obtain second information indicating whether the first electronic device and the second electronic device each receive the data packet retransmitted from the third electronic device during a second time period after the first time period.

According to an embodiment, the instructions are configured to, when executed, cause the first electronic device to identify whether the first electronic device and the second electronic device each receive the data packet at least one time during the first time period and the second time period based on the first information and the second information and to transmit a second response packet indicating NACK or an acknowledgment (ACK) based on a result of the identification to the third electronic device.

According to an embodiment, a method by a first electronic device may comprise sharing information about a received packet with a second electronic device to obtain first information indicating whether the first electronic device and the second electronic device each receive a data packet from a third electronic device during a first time period.

According to an embodiment, the method may further comprise, in case that the first information indicates that the first electronic device and the second electronic device each fail to receive the data packet during the first time period, transmitting a first response packet indicating a negative acknowledgment (NACK) to the third electronic device.

According to an embodiment, the method may further comprise sharing the information about the received packet with the second electronic device to obtain second information indicating whether the first electronic device and the second electronic device each receive the data packet retransmitted from the third electronic device during a second time period after the first time period.

According to an embodiment, the method may further comprise, identifying whether the first electronic device and the second electronic device each receive the data packet at least one time during the first time period and the second time period based on the first information and the second information and transmitting a second response packet indicating NACK or an acknowledgment (ACK) based on a result of the identification to the third electronic device.

According to an embodiment, a non-transitory computer readable storage medium may comprise storing one or more programs comprising instructions configured to, when executed by at least one processor of an electronic device, cause the first electronic device to_share information about a received packet with a second electronic device to obtain first information indicating whether the first electronic device and the second electronic device each receive a data packet from a third electronic device during a first time period.

According to an embodiment, the instructions are configured to, when executed, cause the first electronic device to transmit a first response packet indicating a negative acknowledgment (NACK) to the third electronic device in case that the first information indicates that the first electronic device and the second electronic device each fail to receive the data packet during the first time period.

According to an embodiment, the instructions are configured to, when executed, cause the first electronic device to share the information about the received packet with the second electronic device to obtain second information indicating whether the first electronic device and the second electronic device each receive the data packet retransmitted from the third electronic device during a second time period after the first time period.

According to an embodiment, the instructions are configured to, when executed, cause the first electronic device to identify whether the first electronic device and the second electronic device each receive the data packet at least one time during the first time period and the second time period based on the first information and the second information and to transmit a second response packet indicating NACK or an acknowledgment (ACK) based on a result of the identification to the third electronic device.

### DESCRIPTION OF THE DRAWINGS

FIG. 1 is a block diagram illustrating an electronic device in a network environment according to an embodiment;

FIG. 2 is a view illustrating electronic devices according to an embodiment;

FIG. 3 is a block diagram illustrating a configuration of a first electronic device and a second electronic device according to an embodiment;

FIG. 4 is a block diagram illustrating a configuration of a third electronic device according to an embodiment;

FIG. 5A is a flowchart illustrating an operation for transmitting a response packet to a data packet by a first electronic device according to an embodiment;

FIG. 5B is a flowchart illustrating an operation for transmitting a response packet to a retransmitted data packet by a first electronic device according to an embodiment;

FIG. 6 is a flowchart illustrating an operation for transmitting identification information about a data packet to a first electronic device to share information about a packet received by a second electronic device according to an embodiment;

FIG. 7 is a flowchart illustrating an operation for generating a first communication link with a third electronic device by a first electronic device according to an embodiment;

FIG. 8 is a view illustrating an example of a user interface provided by a third electronic device according to an embodiment;

FIG. 9 is a view illustrating another example of a user interface provided by a third electronic device according to an embodiment;

FIG. 10 is a signal flowchart illustrating an example response packet transmission/reception operation according to an embodiment;

FIG. 11A is a flowchart illustrating an example of an operation for transmitting an ACK packet based on information about a packet received by a first electronic device according to an embodiment;

FIG. 11B is a flowchart illustrating another example of an operation for transmitting an ACK packet based on information about a packet received by a first electronic device according to an embodiment; and

FIG. 12 is a signal flowchart illustrating an example of an operation for transmitting/receiving a response packet considering a previously received data packet according to an embodiment.

### MODE FOR INVENTION

Hereinafter, various embodiments disclosed herein will be described with reference to the accompanying drawings.

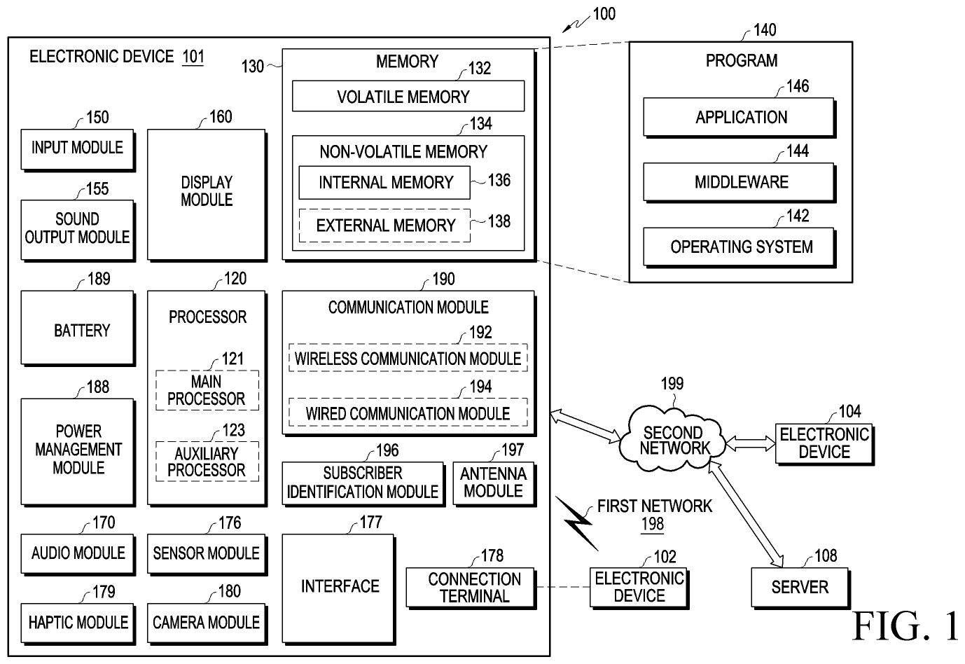

FIG. 1 is a block diagram illustrating an electronic device 101 in a network environment 100 according to an embodiment.

FIG. 1 is a block diagram illustrating an electronic device 101 in a network environment 100 according to an embodiment. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

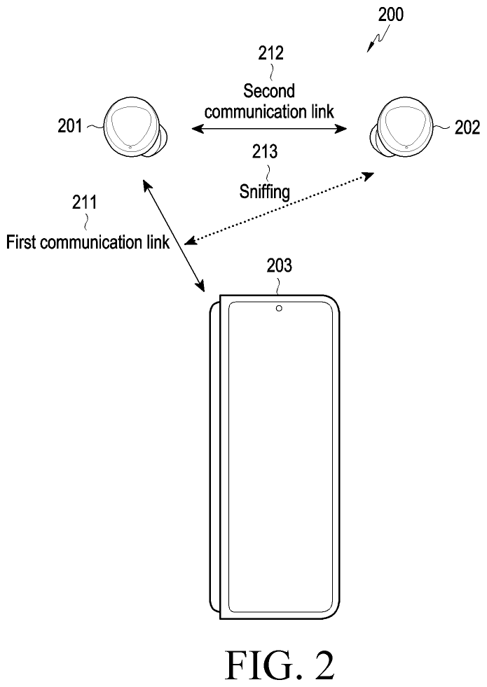

FIG. 2 is a view 200 illustrating electronic devices according to an embodiment.

Referring to FIG. 2, according to an embodiment, the electronic devices may include a first electronic device 201, a second electronic device 202, and a third electronic device 203. According to an embodiment, the first electronic device 201 and the second electronic device 202 each may be the electronic device 102 or the electronic device 104 of FIG. 1 and may be two or more electronic devices (e.g., earbud devices) operating like a single electronic device, such as true wireless stereo (TWS) devices. According to an embodiment, the third electronic device 203 may be the electronic device 101 of FIG. 1 and may be a smart phone.

According to an embodiment, the first electronic device 201 may create a first communication link 211 for communicating with the third electronic device 203. The first electronic device 201 may receive a data packet from the third electronic device 203 through the first communication link 211 and may transmit a response packet to the received data packet, to the third electronic device 203 through the first communication link 211. According to an embodiment, the data packet may be a packet including at least one of media data, audio data, or voice data. Other data types are possible, and the content and structure of the data within the data packet and the structure of the data packet itself is not meant to be particularly limited.

The first electronic device 201 may create a second communication link 212 for communicating with the second electronic device 202. The first electronic device 201 may transmit information about the first communication link 211 to the second electronic device 202 through the second communication link 212.

According to an embodiment, the information about the first communication link 211 may include at least one of device address information (e.g., Bluetooth device address (BD_ADDR) information) about the third electronic device 203, logical transport (LT) address information, information allocated by the device (e.g., the first electronic device 201 or the third electronic device 203) having transmitted a frequency hop synchronization (FHS) packet through the first communication link 211, clock information (e.g., clock native information about the device having transmitted the FHS packet through the first communication link 211), link key information, used channel map information, service discovery protocol (SDP) information (e.g., service and/or profile information associated with the first communication link 211), supported feature information, or extended inquiry response (EIR) information (e.g., resource control information about the first communication link 211).

Table 1 below exemplifies information about the first communication link 211.

TABLE 1

| Information | Size | | Description |
|---|---|---|---|
| Used channel map information | 10 | byte | 0xFF FF FF FF FF FF FF |
| | | | FF FF 7F |
| Device address information | 6 | byte | 0x12 34 56 00 99 88 |
| about third electronic device | | | |
| Clock information | 4 | byte | 0x00 8A F1 7C |
| Link key information | 16 | byte | 0xc9 80 b2 d1 13 f3 2d 89 |
| | | | 95 8b 6e 65 1c fe 89 be |
| SDP information | Variable | | 0x fd 12 22 45 9d 09 |
| LT address information | 3 | bit | 0x1 |

Referring to Table 1, the second electronic device 202 may identify a set of one or more channels to be used in the first communication link 211 and/or a set of one or more channels not to be used in the first communication link 211 based on the used channel map information. For example, the second electronic device 202 may identify that the channels allocated for Bluetooth communication all may be used in the first communication link 211, based on the used channel map information of Table 1, “0xFF FF FF FF FF FF FF FF FF 7F.”

The second electronic device 202 may identify a channel for channel hopping in the first communication link 211 based on the device address information and clock information about the third electronic device 203. For example, the second electronic device 202 may perform a channel operation using the whole or part (e.g., 56 00 99 88) of the device address information “0x12 34 56 00 99 88” about the third electronic device 203 and the whole or part (e.g., 0x00 8A F1 7C) of the clock information “0x00 8A F1 7C” and identify the channel for channel hopping in the first communication link 211 based on the result of the channel operation. The second electronic device 202 may decrypt an encrypted data packet transmitted from the third electronic device 203 through the first communication link 211, using the link key information (e.g., 0x00 8A F1 7C).

The second electronic device 202 may identify service and/or profile information associated with the first communication link 211, using the SDP information (e.g., 0xfd 12 22 45 9d 09).

The second electronic device 206 may generate a response packet to be transmitted to the third electronic device 203 using the LT address information (e.g., 0x1). For example, the second electronic device 206 may generate a response packet including the LT address information.

The second electronic device 202 may monitor the first communication link 211 through a sniffing operation 213 based on the information about the first communication link 211 as described above. For example, the second electronic device 202 may monitor whether a data packet is received from the third electronic device 203 through the first communication link 211.

If the first electronic device 201 receives the data packet from the third electronic device 203 through the first communication link 211, the first electronic device 201 may obtain identification information about the data packet based on the received data packet. The identification information about the data packet may include detailed information about the data packet that may be used to identify the data packet.

According to an embodiment, the identification information about the data packet may include the sequence number of the data packet. According to an embodiment, the information about the data packet may further include, along with the sequence number of the data packet, at least one of operation code (opcode) information about the data packet, type information about the data packet, size information about the data packet, clock information about the time of reception of the data packet, codec information related to the data packet, channel profile information related to the data packet (e.g., L2CAP information, such as the packet ID or signal ID of the data packet and/or the channel identifier (ID) for the channel through which the data packet has been transmitted), or received signal strength information (e.g., receiver signal strength indicator (RSSI) information) about the data packet.

The second electronic device 202 may monitor the first communication link 211 to determine whether the data packet has been received from the third electronic device 203, and transmit, to the first electronic device 201, information indicating whether the second electronic device 202 has received the data packet and/or identification information about the data packet, as information about the received packet, based on the determination result.

The first electronic device 201 may determine whether the second electronic device 202 has received the same data packet as that of the first electronic device 201 based on the information about the packet received from the second electronic device 202. Upon determining that the second electronic device 202 has received the same data packet as that of the first electronic device 201, the first electronic device 201 may transmit a response packet indicating an acknowledgment (ACK) to the third electronic device 203.

According to an embodiment, the response packet indicating the ACK may represent a packet including the bit value (e.g., 1) indicating the ACK. According to an embodiment, the response packet indicating a negative acknowledgment (NACK) may represent a packet including the bit value (e.g., 0) indicating the NACK. According to an embodiment, the bit value indicating the ACK or the bit value indicating the NACK may be included in the header of the response packet. Hereinafter, the response packet indicating the ACK is referred to as an ‘ACK packet,’ and the response packet indicating the NACK is referred to as a ‘NACK packet.’

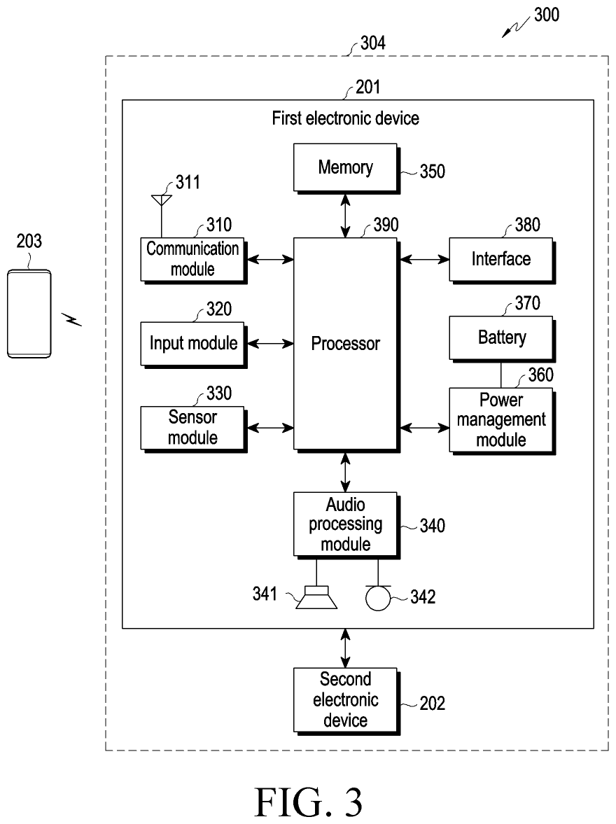

FIG. 3 is a block diagram 300 illustrating a configuration of a first electronic device 201 and a second electronic device 202 according to an embodiment.

Referring to FIG. 3, the first electronic device 201 and the second electronic device 202 may be TWS devices (e.g., earbud devices) configured in pair 304. For example, the first electronic device 201 may be one of the left earbud device and the right earbud device, and the second electronic device 202 may be the other of the left earbud device and the right earbud device.

According to an embodiment, the first electronic device 201 may include an antenna module 311 (e.g., the antenna module 197 of FIG. 1), a communication module 310 (e.g., the communication module 190 of FIG. 1), an input module 320 (e.g., the input module 150 of FIG. 1), a sensor module 330 (e.g., the sensor module 176 of FIG. 1), an audio processing module 340, a memory 350 (e.g., the memory 132 of FIG. 1), and a power management module 360 (e.g., the power management module 188 of FIG. 1), a battery 370 (e.g., the battery 189 of FIG. 1), an interface 380 (e.g., the interface 177 of FIG. 1), and a processor 390.

According to an embodiment, the communication module 310 may be a wireless communication module and may include a module for Bluetooth legacy (or classic) communication and/or Bluetooth low energy (BLE) communication. The communication module 310 may include one or more communication processors that are operable independently from the processor 390 and supports wireless communication. In an embodiment, the communication module 310 may be referred to as a communication interface or communication circuit.

According to an embodiment, the communication module 310 may communicate with the second electronic device 202 and/or the third electronic device 203. For example, the communication module 310 may receive a data packet from the third electronic device 203 through the first communication link 211 established with the third electronic device 203. The communication module 310 may receive information about the packet received from the second electronic device 202 through the second communication link 212 established with the second electronic device 202 (e.g., information indicating whether the second electronic device 202 receives the data packet and/or identification information about the data packet received by the second electronic device 202) and may transmit an ACK packet or NACK packet to the third electronic device 203 through the first communication link.

According to an embodiment, the antenna module 311 may transmit a packet or information to the second electronic device 202 or third electronic device 203 or may receive a packet or information from the second electronic device 202 or the third electronic device 203. According to an embodiment, the antenna module 311 may include a plurality of antennas. According to an embodiment, at least one antenna appropriate for the communication scheme used by the communication network (e.g., the first network 198 of FIG. 1) may be selected from among the plurality of antennas by the communication module 310. Information about the data packet, response packet, or received packet may be transmitted or received between the communication module 310 and another electronic device (e.g., the second electronic device 202 or third electronic device 203) through the selected at least one antenna.

According to an embodiment, the input module 320 may be configured to generate various input signals that may be used for operation of the first electronic device 201. The input module 320 may include a touch pad, a touch panel, or a button. The touch pad may recognize touch inputs in at least one of capacitive, resistive, infrared, or ultrasonic methods. If a capacitive touch pad is provided, physical contact or proximity recognition may be possible. The touch pad may further include a tactile layer. The touch pad including the tactile layer may provide a tactile response to the user. The button may include, e.g., a physical button or an optical key.

According to an embodiment, the input module 320 may receive the user input associated with data (e.g., audio data or multimedia data). For example, the user input may be associated with functions of starting playback of data, pausing playback, stopping playback, adjusting playback speed, adjusting playback volume, or muting. The operation of the first electronic device 201 may be controlled by various gestures, such as tapping or swiping up/down the surface on which the touch pad is installed.

According to an embodiment, the sensor module 330 may identify a position or operational state of the first electronic device 201. The sensor module 330 may convert the measured or identified information into an electrical signal. The sensor module 330 may include at least one of, e.g., a magnetic sensor, an acceleration sensor, a gyro sensor, a geomagnetic sensor, a proximity sensor, a gesture sensor, a grip sensor, a biometric sensor, or an optical sensor. In an embodiment, the optical sensor may include a light emitting unit (e.g., a light emitting diode (LED)) that outputs light of at least one wavelength band. The optical sensor may include a light receiving unit (e.g., a photodiode) that receives light of one or more wavelength bands scattered or reflected from an object and generates an electrical signal.

According to an embodiment, the audio processing module 340 may support an audio data gathering function and reproduce the gathered audio data. According to an embodiment, the audio processing module 340 may include an audio decoder (not shown) and a D/A converter (not shown). The audio decoder may convert audio data stored in the memory 350 or received from the third electronic device 203 through the communication module 310 into a digital audio signal. The D/A converter may convert the digital audio signal converted by the audio decoder into an analog audio signal. According to an embodiment, the audio decoder may convert audio data received from the third electronic device 203 through the communication module 310 and stored in the memory 350 into a digital audio signal. The speaker 341 may output the analog audio signal converted by the D/A converter. According to an embodiment, the audio processing module 340 may include an A/D converter (not shown). The A/D converter may convert the analog audio signal transferred through the microphone 342 into a digital voice signal.

According to an embodiment, the microphone 342 may include at least one air conduction microphone and/or at least one bone conduction microphone for detecting voice. The air conduction microphone may detect the voice (e.g., the user's utterance) transferred through air and output a voice signal corresponding to the detected voice. The bone conduction microphone may measure the vibration of the user's bone (e.g., skull) due to the user's utterance and may output a voice signal corresponding to the measured vibration. The bone conduction microphone may be referred to as a bone conduction sensor or by other various terms. The voice detected by the air conduction microphone is a voice mixed with external noise while the user's utterance is transferred through the air, whereas the voice detected by the bone conduction microphone may be mixed with less noise (e.g., influence by noise) because it is detected from the vibration of the bone. Therefore, the bone conduction microphone may output a voice signal corresponding to the user's voice with reduced external noise even in a high-noise environment. According to an embodiment, the voice signal output from the microphone 342 may be transferred to the processor 390. According to an embodiment, an acceleration sensor (e.g., the sensor module 330) may be used to obtain a voice signal corresponding to the user's voice with reduced external noise. For example, the acceleration sensor may measure the vibration of the user's skin due to the user's voice utterance and output a voice signal corresponding to the measured vibration to the processor 390. Since the voice (e.g., vibration) detected by the acceleration sensor is detected from the vibration of the skin, the inflow of external noise (e.g., the influence by noise) may be small. The above-described bone conduction microphone and/or acceleration sensor may be referred to as a voice pickup unit (VPU) or may be referred to in other various terms.

According to an embodiment, the audio processing module 340 may play various audio data set in the operation of the first electronic device 201. For example, the processor 390 may be designed to detect insertion or removal of the first electronic device 201 into/from the user's ear through the sensor module 330 and reproduce audio data regarding an effect sound or guide sound through the audio processing module 340. The output of the sound effect or guide sound may be omitted according to the user setting or the designer's intention.

According to an embodiment, the memory 350 may store various data used by at least one component (e.g., the processor 390 or a sensor module 330) of the first electronic device 201. The various data may include, for example, software and input data or output data for a command related thereto. According to an embodiment, the data may include at least one of the identification information about the data packet, the information about whether the first electronic device 201 has received the data packet, and/or the information about whether the second electronic device 202 has received the data packet. The memory 350 may include a volatile memory or a non-volatile memory.

According to an embodiment, the power management module 360 may manage power supplied to the first electronic device 201. According to one embodiment, the power management module 360 may be implemented as at least part of, for example, a power management integrated circuit (PMIC). According to an embodiment, the power management module 360 may include a battery charging module. According to an embodiment, when the third electronic device 203 is electrically connected to the first electronic device 201 (wirelessly or wiredly), the power management module 360 may receive power from the third electronic device 203 and charge the battery 370.

According to an embodiment, the battery 370 may supply power to at least one component of the first electronic device 201. According to an embodiment, the battery 370 may include, e.g., a rechargeable battery.

According to an embodiment, the interface 380 may support one or more designated protocols that may be used for the first electronic device 201 to directly (e.g., wiredly) connect to the second electronic device 202, the third electronic device 203, and/or another electronic device. According to an embodiment, the interface 380 may include, for example, a high definition multimedia interface (HDMI), a USB interface, a secure digital (SD) card interface, or an audio interface. According to an embodiment, the interface 380 may include a connection port for forming a physical connection with the third electronic device 203.

According to an embodiment, the processor 390 may execute, e.g., software to control at least one other component (e.g., a hardware or software component) of the first electronic device 201 connected with the processor 390 and may process or compute various data. According to an embodiment, as at least part of the data processing or computation, the processor 390 may load a command or data received from another component (e.g., the sensor module 330 or communication module 310) onto a volatile memory 350, process the command or the data stored in the volatile memory, and store resulting data in a non-volatile memory.

According to an embodiment, the processor 390 may establish a first communication link (e.g., the first communication link 211 of FIG. 2) with the third electronic device 203 through the communication module 310 and may receive the data packet from the third electronic device 203 through the established first communication link. According to an embodiment, the processor 390 may detect data (e.g., audio data) from the data packet received from the third electronic device 203 and may process the detected data through the audio processing module 340 and output it to the speaker 341.

According to an embodiment, the processor 390 may perform all or some of the operations of the first electronic device 201 described with reference to FIG. 2 and/or the operations of the first electronic device described below.

According to an embodiment, the first electronic device 201 may further include various modules depending on the form in which it is provided. There are many variations according to the convergence trend of digital devices, so it is not possible to list them all, but components equivalent to the above-mentioned components may be further included in the first electronic device 201. Further, it is apparent that in the first electronic device 201 according to an embodiment, specific components may be excluded from the above components or replaced with other components according to the form in which it is provided. This will be easily understood by those of ordinary skill in the art.

According to an embodiment, the second electronic device 202 is a device configured in pair with the first electronic device 201 and may include the same or similar components to those included in the first electronic device 201. The second electronic device 202 may perform all or some of the operations of the second electronic device 202 described with reference to FIG. 2 and/or the operations of the second electronic device 202 described below in connection with the drawings.

According to an embodiment, in addition to the second electronic device 202, one or more additional electronic devices (not separately shown) configured in pair 304 with the first electronic device 201 may be further included. One or more electronic devices may also include the same or similar components included in the first electronic device 201 and may perform the same or similar operations as all or some of the operations of the first electronic device 201 or the second electronic device 202 described below with reference to the drawings.

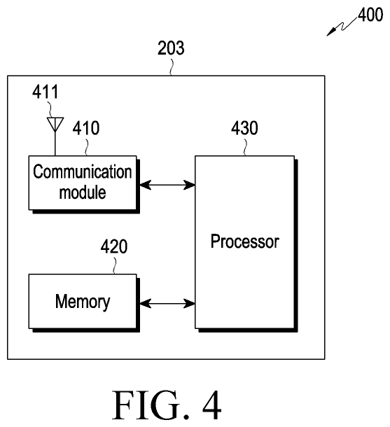

FIG. 4 is a block diagram 400 illustrating a third electronic device 203 according to an embodiment.

According to an embodiment, the third electronic device 203 may include the same or similar components to at least one of the components (e.g., modules) of the electronic device 101 illustrated in FIG. 1.

Referring to FIG. 4, the third electronic device 203 may include an antenna module 411 (e.g., the antenna module 197 of FIG. 1), a communication module 410 (e.g., the communication module 190 of FIG. 1), a memory 420 (e.g., the memory 132 of FIG. 1), and a processor 430 (e.g., the processor 120 of FIG. 1).

According to an embodiment, the communication module 410 may be a wireless communication module and may include a module for Bluetooth legacy communication and/or BLE communication. The communication module 410 may include one or more communication processors that are operable independently from the processor 430 and supports wireless communication. In an embodiment, the communication module 410 may be referred to as a communication interface or communication circuit.

According to an embodiment, the communication module 410 may directly or indirectly communicate with at least one external electronic device (e.g., the first electronic device 201 and/or the second electronic device 202 of FIG. 3). The communication module 310 may transmit a data packet to at least one external electronic device and may or may not receive a response packet (e.g., an ACK packet or a NACK packet) to the transmitted data packet from at least one external electronic device for a set time period. In an embodiment, when the communication module 310 does not receive the response packet for the set time, it may be determined that a NACK packet has been received. Accordingly, an operation similar to that when the NACK packet is received may be performed by the processor 430.

The antenna module 411 may include a plurality of antennas, and at least one antenna appropriate for the communication scheme used by the communication network (e.g., the first network 198 of FIG. 1) may be selected from among the plurality of antennas by the communication module 410. According to an embodiment, the data packet or response packet may be transmitted or received between the communication module 410 and at least one external electronic device through the selected at least one antenna.

According to an embodiment, the memory 420 may store various pieces of information used by at least one component (e.g., the communication module 410 and/or the processor 430) of the third electronic device 203. The information stored in the memory 420 may include, for example, software and input data or output data for a command related thereto. According to an embodiment, the information stored in the memory 420 may include data (e.g., audio data) to be included in the data packet to be transmitted. The memory 420 may include a volatile memory or a non-volatile memory.

According to an embodiment, the processor 430 may execute, e.g., software to control at least one other component (e.g., a hardware or software component) of the third electronic device 203 connected with the processor 430 and may process or compute various data. According to an embodiment, as at least part of the data processing or computation, the processor 430 may load a command or data received from another component (e.g., the communication module 410) onto a volatile memory 420, process the command or the data stored in the volatile memory, and store resulting data in a non-volatile memory.

According to an embodiment, the processor 430 may perform all or some of the operations of the third electronic device 203 described in connection with FIG. 2 and/or the operations of the third electronic device 203 described below.

According to an embodiment, the third electronic device 203 may further include various modules depending on the form in which it is provided. There are many variations according to the convergence trend of digital devices, so it is not possible to list them all, but components equivalent to the above-mentioned components may be further included in the third electronic device 203. Further, it is apparent that in the third electronic device 203 according to an embodiment, specific components may be excluded from the above components or replaced with other components according to the form in which it is provided. This will be easily understood by those of ordinary skill in the art, and all such module and component configurations are within the contemplated scope of the disclosure.

According to an embodiment, a first electronic device (e.g., the electronic device 102 or electronic device 104 of FIG. 1 and the first electronic device 201 of FIG. 2) may comprise a memory (e.g., the memory 350 of FIG. 3), a communication module (e.g., the communication module 310 of FIG. 3) for performing communication with a second electronic device (e.g., the electronic device 102 of FIG. 1, the electronic device 104 of FIG. 1, or the second electronic device 202 of FIG. 2) or a third electronic device (e.g., the electronic device 101 of FIG. 1 and the third electronic device 203 of FIG. 2), and at least one processor (e.g., the processor 390 of FIG. 3) operatively connected with the memory and the communication module.

According to an embodiment, the memory may store instructions to, when executed, enable the at least one processor to share information about a received packet with the second electronic device to obtain first information indicating whether the first electronic device and the second electronic device each receive a data packet from the third electronic device during a first time period.

According to an embodiment, the memory may store further instructions to, when executed, enable the first electronic device to transmit a first response packet indicating a negative acknowledgment (NACK) to the third electronic device in case that the first information indicated that the first electronic device and the second electronic device each fail to receive the data packet during the first time period.

According to an embodiment, the memory may store further instructions to, when executed, enable the first electronic device to share the information about the packet with the second electronic device to obtain second information indicating whether the first electronic device and the second electronic device each receive the data packet retransmitted from the third electronic device during a second time period after the first time period.

According to an embodiment, the memory may store further instructions to, when executed, enable the first electronic device to identify whether the first electronic device and the second electronic device each receive the data packet at least one time during the first time period and the second time period based on the first information and the second information and transmit a second response packet indicating NACK or an acknowledgment (ACK) based on a result of the identification to the third electronic device.

According to an embodiment, when executed, the instructions may enable the first electronic device to, in case that the first information indicates that the first electronic device and the second electronic device each receive the data packet during the first time period, transmit the first response packet indicating ACK to the third electronic device.

According to an embodiment, when executed, the instructions may enable the first electronic device to, upon identifying that the first electronic device and the second electronic device each receive the data packet at least one time during the first time period and the second time period, transmit the second response packet indicating the ACK to the third electronic device.

According to an embodiment, when executed, the instructions may enable the first electronic device to, upon identifying that the first electronic device and the second electronic device each fail to receive the data packet at least one time during the first time period and the second time period, transmit the second response packet indicating the NACK to the third electronic device.

According to an embodiment, when executed, the instructions may enable the first electronic device to, upon identifying that the first electronic device and the second electronic device each fail to receive the data packet at least one time during the first time period and the second time period, transmit the second response packet indicating the NACK to the third electronic device, share the information about the received packet with the second electronic device to obtain third information indicating whether the first electronic device and the second electronic device each receive the data packet retransmitted from the third electronic device during a third time period after the second time period, and upon identifying that the first electronic device and the second electronic device each receive the data packet during the third time period based on the third information, to transmit the third response packet indicating ACK to the third electronic device.

According to an embodiment, when executed, the instructions may enable the first electronic device to, in case that the first information indicates that the first electronic device and the second electronic device each receive the data packet during the first time period, detect information about the data packet, identify whether the second electronic device received the data packet from the third electronic device during the first time period, based on whether information corresponding to the detected information is received from the second electronic device, and obtain the first information based on receiving the data packet from the third electronic device during the first time period and identifying whether the second electronic device receives the data packet from the third electronic device during the first time period.

According to an embodiment, when executed, the instructions may enable the first electronic device to, in case that the first information indicates that the first electronic device and the second electronic device each receive the data packet during the first time period, detect information about the data packet, transmit the detected information to the second electronic device, identify whether the second electronic device receives the data packet from the third electronic device during the first time period, based on whether a response signal to the transmitted information is received from the second electronic device, and obtain the first information based on receiving the data packet from the third electronic device during the first time period and identifying whether the second electronic device receives the data packet from the third electronic device during the first time period.

According to an embodiment, when executed, the instructions may enable the first electronic device to, upon receiving the data packet from the third electronic device during the second time period, detect information about the data packet, identify whether the second electronic device received the data packet from the third electronic device during the second time period, based on whether information corresponding to the detected information is received from the second electronic device, and obtain the second information based on receiving the data packet from the third electronic device during the second time period and identifying whether the second electronic device receives the data packet from the third electronic device during the second time period.

According to an embodiment, when executed, the instructions may enable the first electronic device to, upon receiving the data packet from the third electronic device during the second time period, detect information about the data packet, transmit the detected information to the second electronic device, identify whether the second electronic device receives the data packet from the third electronic device during the second time period, based on whether a response signal to the transmitted information is received from the second electronic device, and obtain the second information based on receiving the data packet from the third electronic device during the second time period and identifying whether the second electronic device receives the data packet from the third electronic device during the second time period.

According to an embodiment, information about the received data packet shared with the second electronic device may include at least one of sequence number information about the data packet received from the third electronic device, operation code (opcode) information about the data packet received from the third electronic device, type information about the data packet received from the third electronic device, size information about the data packet received from the third electronic device, clock information about a time of receiving the data packet from the third electronic device, codec information related to the data packet received from the third electronic device, channel profile information related to the data packet received from the third electronic device, or received signal strength information about the data packet received from the third electronic device.

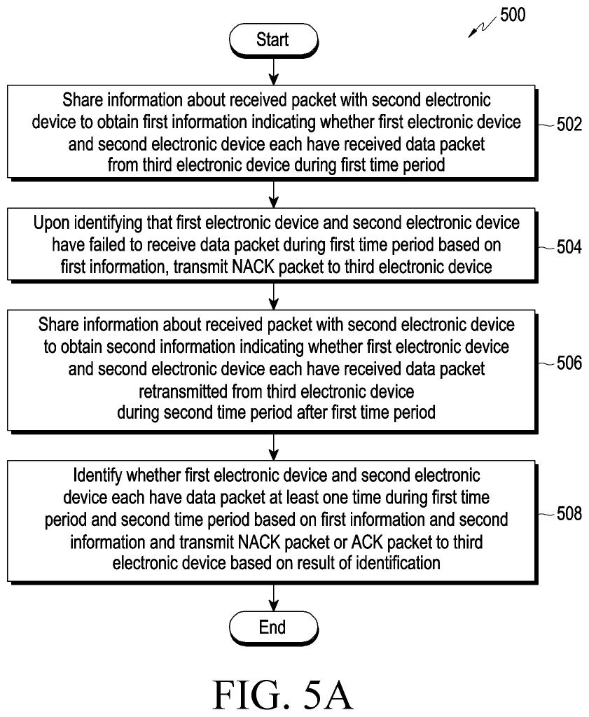

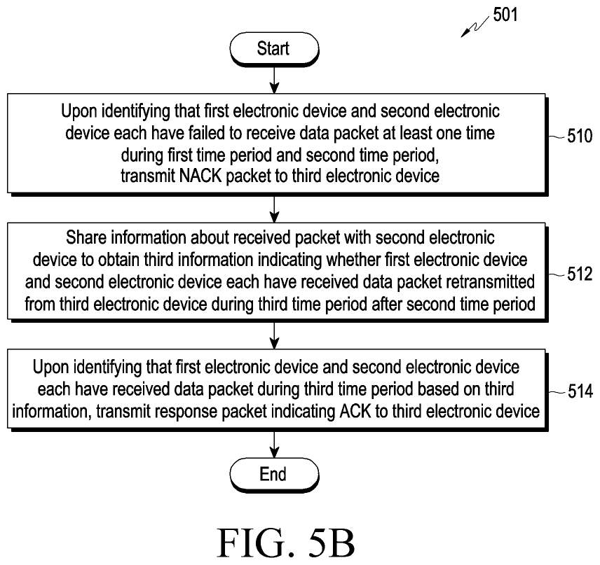

Hereinafter, operations of the first electronic device 201, the second electronic device 202, and the third electronic device 203 according to an embodiment are described with reference to FIGS. 5A to 14.

FIG. 5A is a flowchart 500 illustrating an operation for transmitting a response packet to a data packet by a first electronic device 201 according to an embodiment.

According to an embodiment, the operations illustrated in FIG. 5A may be performed after the first electronic device 201 establishes the first communication link 211 and the second communication link 212 and transmits information about the first communication link 211 to the second electronic device 202 through the second communication link 212. In an embodiment to be described below, communication between the first electronic device 201 and the third electronic device 203 may be performed through the first communication link 211, and communication between the first electronic device 201 and the second electronic device 202 may be performed through the second communication link 212.

Referring to FIG. 5A, in operation 502, the first electronic device 201 may share information about a received packet with the second electronic device 202 to obtain first information indicating whether the first electronic device 201 and the second electronic device 202 each receive a data packet from the third electronic device 203 during a first time period.

According to an embodiment, the information about the received packet may include information about the data packet received from the third electronic device 203. According to an embodiment, the information about the received data packet may include at least one of sequence number information about the received data packet, as identification information about the received data packet, operation code (opcode) information about the received data packet, type information about the received data packet, size information about the received data packet, clock information about the time of reception of the received data packet, codec information related to the received data packet, channel profile information related to the received data packet (e.g., L2CAP information, such as the packet ID or signal ID of the received data packet and/or the channel ID for the channel through which the received data packet has been transmitted), or received signal strength information (e.g., RSSI information) about the received data packet.

According to an embodiment, upon receiving the data packet from the third electronic device 203 during the first time period, the first electronic device 201 may detect information about the data packet (e.g., the identification information about the data packet). Based on whether information corresponding to the information detected from the second electronic device 202 is received, the first electronic device 201 may identify whether the second electronic device 202 receives the data packet from the third electronic device 203 during the first time period. The first electronic device 201 may obtain the first information based on receiving the data packet from the third electronic device 203 during the first time period and identifying whether the second electronic device 202 receives the data packet from the third electronic device 203 during the first time period.

According to an embodiment, upon receiving the data packet from the third electronic device 203 during the first time period, the first electronic device 201 may detect information about the data packet (e.g., the identification information about the data packet). The first electronic device 201 may transmit the detected information to the second electronic device and, based on whether a response packet to the transmitted information is received from the second electronic device 202, identify whether the second electronic device 202 receives the data packet from the third electronic device 203 during the first time period. The first electronic device 201 may obtain the first information based on receiving the data packet from the third electronic device 203 during the first time period and identifying whether the second electronic device 202 receives the data packet from the third electronic device 203 during the first time period.

In operation 504, upon identifying that the first electronic device 201 and second electronic device 202 each fail to receive the data packet during the first time period, based on the first information, the first electronic device 201 may transmit a NACK packet to the third electronic device 203. According to an embodiment, the first electronic device 201 may transmit no response packet (e.g., an ACK packet or NACK packet) rather than transmitting a NACK packet.

According to an embodiment, if a cyclic redundancy check (CRC) for the data packet or header error occurs although the first electronic device 201 receives the data packet, the first electronic device 201 may identify that the data packet is not received. In this case, the first electronic device 201 may transmit a NACK packet to the third electronic device 203 regardless of whether the second electronic device 202 receives the data packet. As another example, upon failing to receive the data packet within a designated time, the first electronic device 201 may transmit no response packet (e.g., an ACK or NACK packet) to the third electronic device 203 regardless of whether the second electronic device 202 receives the data packet.

According to an embodiment, upon identifying that the first electronic device 201 and second electronic device 202 each receive the data packet during the first time period, the first electronic device 201 may transmit an ACK packet to the third electronic device 203.

In operation 506, the first electronic device 201 may share information about a received packet with the second electronic device 202 to obtain second information indicating whether the first electronic device 201 and the second electronic device 202 each receive the data packet retransmitted from the third electronic device 203 during a second time period after the first time period.

According to an embodiment, upon receiving the data packet from the third electronic device 203 during the second time period, the first electronic device 201 may detect information about the data packet (e.g., the identification information about the data packet). Based on whether information corresponding to the information detected from the second electronic device 202 is received, the first electronic device 201 may identify whether the second electronic device 202 receives the data packet from the third electronic device 203 during the second time period. The first electronic device 201 may obtain the second information based on receiving the data packet from the third electronic device 203 during the second time period and identifying whether the second electronic device 202 receives the data packet from the third electronic device 203 during the second time period.

According to an embodiment, upon receiving the data packet from the third electronic device 203 during the second time period, the first electronic device 201 may detect information about the data packet (e.g., the identification information about the data packet). The first electronic device 201 may transmit the detected information to the second electronic device 202 and, based on whether a response packet to the transmitted information is received from the second electronic device 202, identify whether the second electronic device 202 receives the data packet from the third electronic device 203 during the second time period. The first electronic device 201 may obtain the second information based on receiving the data packet from the third electronic device 203 during the second time period and identifying whether the second electronic device 202 receives the data packet from the third electronic device 203 during the second time period.

In operation 508, the first electronic device 201 may identify whether the first electronic device 201 and second electronic device 202 each receive the data packet at least one time during the first time period and second time period based on the first information and second information and, based on a result of the identification, transmit a NACK packet or ACK packet to the third electronic device 203.

According to an embodiment, the first electronic device 201 may transmit a response packet determined based on a condition set forth in Table 2 to the third electronic device 203.

Table 2 shows response packets based on whether the first electronic device 201 and second electronic device 202 each receive the data packet during the first time period and whether the first electronic device 201 and second electronic device 202 each receive the data packet retransmitted from the third electronic device 203 during the second time period.

TABLE 2

| | | First time | Second time | Response |
|---|---|---|---|---|
| | | period | period | packet |
| 1 | First electronic | Reception | Reception | ACK |
| | device | succeeds | fails | packet |
| | Second electronic | Reception | Reception | |
| | device | fails | succeeds | |
| 2 | First electronic | Reception | Reception | ACK |
| | device | fails | succeeds | packet |
| | Second electronic | Reception | Reception | |
| | device | succeeds | fails | |
| 3 | First electronic | Reception | Reception | ACK |
| | device | succeeds | succeeds | packet |
| | Second electronic | Reception | Reception | |
| | device | fails | succeeds | |
| 4 | First electronic | Reception | Reception | ACK |
| | device | fails | succeeds | packet |
| | Second electronic | Reception | Reception | |
| | device | succeeds | succeeds | |
| 5 | First electronic | Reception | Reception | NACK |
| | device | succeeds | succeeds | packet |
| | Second electronic | Reception | Reception | |
| | device | fails | fails | |
| 6 | First electronic | Reception | Reception | NACK |
| | device | fails | fails | packet |
| | Second electronic | Reception | Reception | |
| | device | succeeds | succeeds | |
| 7 | First electronic | Reception | Reception | NACK |
| | device | fails | fails | packet |
| | Second electronic | Reception | Reception | |
| | device | fails | succeeds | |
| 8 | First electronic | Reception | Reception | NACK |
| | device | fails | succeeds | packet |
| | Second electronic | Reception | Reception | |
| | device | fails | fails | |
| 9 | First electronic | Reception | Reception | NACK |
| | device | fails | fails | packet |
| | Second electronic | Reception | Reception | |
| | device | fails | fails | |

According to an embodiment, as in cases “1 to 4” of Table 2, if the first electronic device 201 succeeds in receiving the data packet at least one time during the first time period and second time period, and the second electronic device 202 succeeds in receiving the data packet at least one time during the first time period and second time period, the first electronic device 201 may transmit an ACK packet to the third electronic device 203.

According to an embodiment, as in cases “5 to 9” of Table 2, if at least one of the first electronic device 201 and the second electronic device 202 never receives the data packet during the first time period and second time period, the first electronic device 201 may transmit a NACK packet to the third electronic device 203 or may transmit no response packet (e.g., ACK or NACK packet) to the third electronic device 203 within a set time.

According to an embodiment, as in case “2, 4, or 6” of Table 2, when the first electronic device 201 fails to receive the data packet during the first time period, and the second electronic device 202 succeeds in receiving the data packet during the first time period, the first electronic device 201 may omit the operation for identifying whether the second electronic device 202 receives the data packet during the second time period (e.g., the operation for sharing the information about the received information with the second electronic device 202).

For example, considering that the second electronic device 202 succeeds in receiving the data packet during the first time period, the first electronic device 201 may transmit an ACK or NACK packet to the third electronic device 203 based on whether the first electronic device 201 succeeds in receiving the data packet, regardless of whether the second electronic device 202 succeeds in receiving the data packet during the second time period. In case “2 or 4” of Table 2, when the first electronic device 201 succeeds in receiving the data packet during the second time period, the first electronic device 201 may transmit an ACK packet to the third electronic device 203. In case “6” of Table 2, when the first electronic device 201 fails to receive the data packet during the second time period, the first electronic device 201 may transmit a NACK packet to the third electronic device 203.

FIG. 5B is a flowchart 501 illustrating an operation for transmitting a response packet to a retransmitted data packet by a first electronic device 201 according to an embodiment.

Referring to FIG. 5B, in operation 510, upon identifying that the first electronic device 201 and second electronic device 202 each have never received a data packet during the first time period and the second time period, the first electronic device 201 may transmit a NACK packet to the third electronic device 203. According to an embodiment, operation 510, as an operation associated with operation 508 of FIG. 5A, may represent an operation when, in operation 508 of FIG. 5A, the first electronic device 201 transmits a NACK packet to the third electronic device 203.

In operation 512, the first electronic device 201 may share information about received packet with the second electronic device 202 to obtain third information indicating whether the first electronic device 201 and the second electronic device 202 each receive the data packet retransmitted from the third electronic device 203 during a third time period after the second time period.

In operation 514, the first electronic device 201 may identify whether the first electronic device 201 and second electronic device 202 each receive the data packet during the third time period based on the third information and, based on a result of the identification, transmit a NACK packet or an ACK packet to the third electronic device 203.

According to an embodiment, when the first electronic device 201 and the second electronic device 202 each receive the data packet during the third time period, the first electronic device 201 may transmit an ACK packet to the third electronic device 203.

According to an embodiment, when the first electronic device 201 and second electronic device 202 each fail to receive the data packet during the third time period, the first electronic device 201 may transmit a NACK packet to the third electronic device 203.

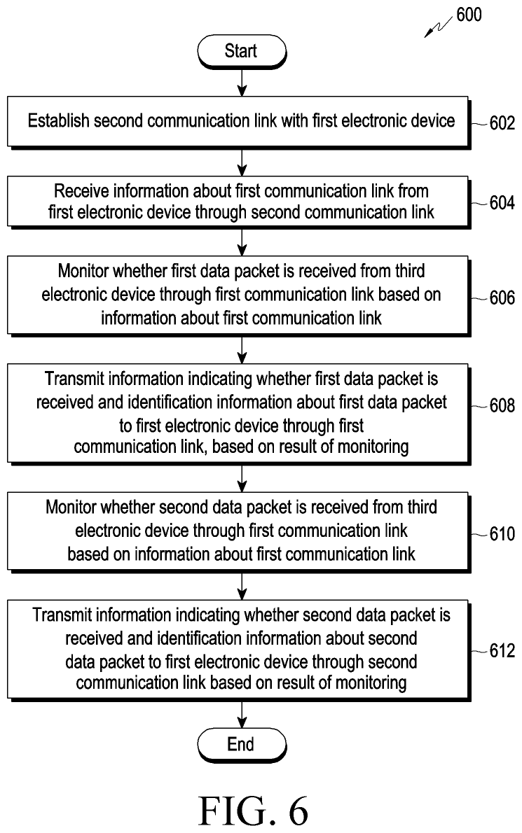

FIG. 6 is a flowchart 600 illustrating an operation for transmitting identification information about a data packet to a first electronic device 201 to share information about a packet received by a second electronic device 202 according to an embodiment.

Referring to FIG. 6, the second electronic device 202 may establish a second communication link 212 with the first electronic device 201 in operation 602.

In operation 604, the second electronic device 202 may receive information about the first communication link 211 from the first electronic device 201 through the second communication link 212. According to an embodiment, the information about the first communication link 211 may include information about the first communication link 211 established between the first electronic device 201 and the third electronic device 203.

In operation 606, the second electronic device 202 may monitor whether a first data packet is received from the third electronic device 203 through the first communication link 211 based on the information about the first communication link 211. According to an embodiment, the information about the first communication link 211 may include at least one of device address information, LT address information, clock information, link key information, used channel map information, SDP information, supported feature information, or EIR information about the third electronic device 203, in a similar manner as discussed previously.

In operation 608, the second electronic device 202 may transmit response information indicating whether the first data packet is received and identification information about the first data packet through the second communication link 212 to the first electronic device 201 based on a result of the monitoring of operation 606.

According to an embodiment, upon receiving the first data packet as a result of the monitoring of operation 606, the second electronic device 202 may transmit response information indicating whether the first data packet is received and identification information about the first data packet through the second communication link 212 to the first electronic device 201. In an embodiment, upon failing to receive the first data packet as a result of the monitoring of operation 606, the second electronic device 202 may not transmit response information indicating whether the first data packet is received and identification information about the first data packet.

In operation 610, the second electronic device 202 may monitor whether a second data packet is received from the third electronic device 203 through the first communication link 211 based on the information about the first communication link 211. According to an embodiment, the second data packet may be a next data packet of the first data packet or a retransmitted first data packet.

In operation 612, the second electronic device 202 may transmit response information indicating whether the second data packet is received and identification information about the second data packet through the second communication link 212 to the first electronic device 201 based on a result of the monitoring of operation 610.

According to an embodiment, upon receiving the second data packet as a result of the monitoring of operation 610, the second electronic device 202 may transmit response information indicating whether the second data packet is received and identification information about the second data packet through the second communication link 212 to the first electronic device 201. According to an embodiment, upon failing to receive the second data packet as a result of the monitoring of operation 610, the second electronic device 202 may not transmit response information indicating whether the second data packet is received and identification information about the second data packet.

According to an embodiment, the second electronic device 202 may perform the operation for receiving a second data packet again or perform the operation for receiving a third data packet which is the next packet to the second data packet, based on whether the response information indicating whether the second data packet is received and identification information about the second data packet have been transmitted.

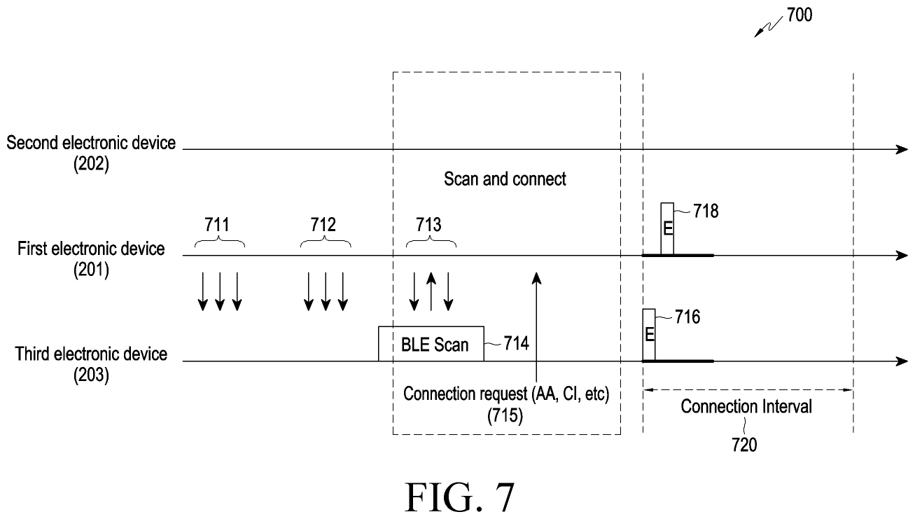

FIG. 7 is a flowchart 700 illustrating an operation for generating a first communication link 211 with a third electronic device 203 by a first electronic device 201 according to an embodiment.

According to an embodiment, the first electronic device 201 may establish a first communication link 211 with the third electronic device 203. In the first communication link 211, data packets (e.g., packets including media data or audio data) may be exchanged and response packets to the received data packets may be transmitted/received between, e.g., the first electronic device 201 and the third electronic device 203. According to an embodiment, the first communication link 211 may be established based on wireless communication (e.g., BLE communication).

Referring to FIG. 7, the first electronic device 201 may generate an advertising signal in a multicast or broadcast manner in operation 711 so that the third electronic device 203 may recognize the first electronic device 201. The advertising signal is a signal transmitted based on wireless communication (e.g., BLE communication) and may be a signal for connecting to an unspecified ambient electronic device (e.g., an audio source) or a signal for transmitting account (e.g., pairing) related signal.

According to an embodiment, the first electronic device 201 may be stored in a case, such as a cradle and may generate an advertising signal when the case is opened while being stored in the case. Alternatively, the case may generate the advertising signal instead of the first electronic device 201.

According to an embodiment, the advertising signal may include at least one of identification information about the first electronic device 201, the user's account information, information regarding whether the first electronic device 201 is currently paired with another device, a list of devices previously paired with the first electronic device 201, information regarding devices simultaneously pairable with the first electronic device 201, transmit power of the first electronic device 201, information regarding the detection area of the first electronic device 201, or information regarding the remaining battery of the first electronic device 201.

According to an embodiment, the first electronic device 201 may generate an advertising signal according to a set condition. For example, when powered on, the first electronic device 201 may generate an advertising signal in operation 711 and then generate an advertising signal in operation 712 based on at least one of a set period or a user input.

According to an embodiment, in operation 714, the third electronic device 203 may perform a scan operation (e.g., a BLE scan operation) for monitoring the advertising signal. The third electronic device 203 may perform an active scan operation or a passive scan operation as the scan operation.

According to an embodiment, the active scan operation may be performed based on operation 713 of the first electronic device 201 and operation 714 of the third electronic device 203. For example, when receiving the advertising signal transmitted by the first electronic device 201, the third electronic device 203 may transmit a scan request packet including information indicating that the advertising signal has been received to the first electronic device 201. Upon receiving the scan request packet, the first electronic device 201 may transmit a scan response packet corresponding to the scan request packet to the third electronic device 203.

According to an embodiment, the third electronic device 203 may perform a passive scan operation for receiving the advertising signal without transmitting a scan request packet.

When the third electronic device 203 receives the advertising signal and recognizes the first electronic device 201, the third electronic device 203 may transmit a connection request to the first electronic device 201 in operation 715. According to an embodiment, the third electronic device 203 may perform a page operation for transmitting a connection request, and the first electronic device 201 may perform a page scan operation for receiving the connection request.

For example, the page operation of the third electronic device 203 may include an operation for transmitting an ID packet as a connection request. The ID packet may include a device access code (DAC) determined based on device address information about the first electronic device 201 and may be periodically transmitted through at least one of a set number of channels.

The page scan operation of the first electronic device 201 may include an operation in which the first electronic device 201 identifies whether there is a connection request using its own device address information, e.g., whether the ID packet is received. The page scan operation may include an operation in which the first electronic device 201 identifies whether the ID packet is received through at least one channel among a number of (e.g., 32) channels set at a set time interval (e.g., 1.28 s).

The first electronic device 201 may receive the ID packet through at least one channel based on the page scan operation. The first electronic device may transmit the same response packet (ID packet) as the ID packet to the third electronic device 203 through the at least one channel through which the ID packet has been received.

Upon receiving the response packet from the first electronic device 201, the third electronic device 203 may transmit an FHS packet to the first electronic device 201. For example, the FHS packet may include at least one of device address information about the third electronic device 203, clock information, or LT address information to be used by the first electronic device 201.

Upon receiving the FHS packet, the first electronic device 201 may notify that the FHS packet has been normally received by transmitting a response packet (ID packet) to the third electronic device 203 once again. Thereafter, the first electronic device 201 and the third electronic device 203 may determine at least one channel among the set number of channels using the device address information and clock information about the third electronic device 203, shared through the FHS packet.

In operation 716, the third electronic device 203 may transmit a POLL packet to the first electronic device 201 through the determined at least one channel, forming a first communication link. The POLL packet may be used for the third electronic device 203, operating as a master device in the connection procedure, to poll the first electronic device 201 (e.g., to instruct the first electronic device 201 to start transmission) which operates as a slave device.

Upon receiving the POLL packet, the first electronic device 201 may be required to respond even when it has no information to transmit. Accordingly, the first electronic device 201 may transmit a NULL packet in operation 718. The NULL packet is a payload-free packet and may be used to return link information about success in previous transmission (e.g., transmission of the POLL packet).

In an embodiment, the POLL packet and the NULL packet may be transmitted/received in a connection interval 720 set in the determined at least one channel. If the POLL packet and the NULL packet are successfully transmitted/received, the first electronic device 201 and the third electronic device 203 may be connected through the established first communication link 211.

According to an embodiment, the first electronic device 201 may establish a second communication link 212 for communication with the second electronic device 202 using a similar method to that shown in FIG. 7 while maintaining the first communication link 211. According to an embodiment, the first electronic device 201 may establish the second communication link 212 earlier than the first communication link 211.

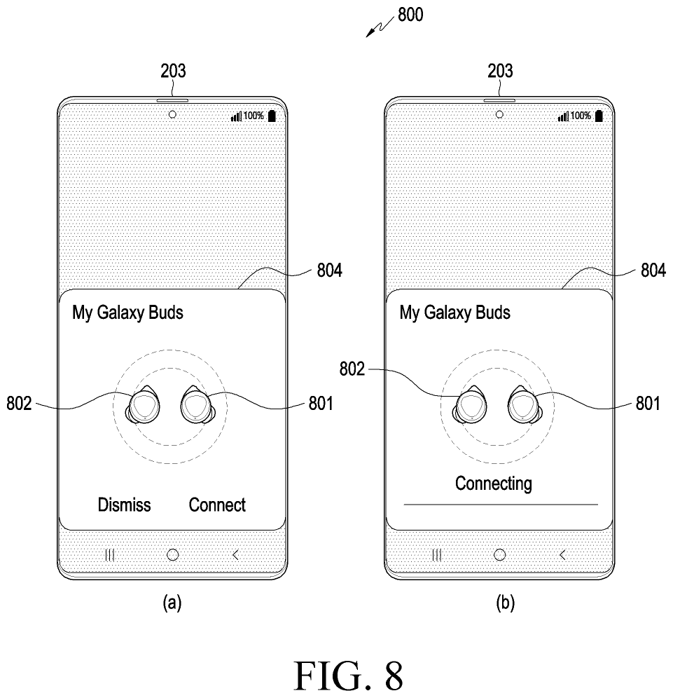

FIG. 8 is a view 800 illustrating an example of a user interface provided by a third electronic device 203 according to an embodiment.

According to an embodiment, upon receiving the advertising signal, the third electronic device 203 may provide a user interface to indicate the device recognized based on the advertising signal. For example, when the third electronic device 203 recognizes the first electronic device 201 based on the advertising signal, the third electronic device 203 may display an icon 801 to indicate the first electronic device 201, on the display (e.g., on the display module 160). Alternatively, as shown in FIG. 8(a), the third electronic device 203 may display, on the display, a second icon 802 to indicate the second electronic device 202 configured in pair with the first electronic device 201, along with the first icon 801 to indicate the first electronic device 201.

According to an embodiment, the third electronic device 203 may display, on the display, a menu (e.g., Dismiss and Connect) to select whether to connect to the device (e.g., the first electronic device 201) recognized based on the advertising signal. According to an embodiment, when “Dismiss” is selected, the third electronic device 203 may determine that the user is not to perform a connection with the first electronic device 201 and may terminate the display of the popup window 804.

According to an embodiment, when “Connect” is selected, the third electronic device 203 may determine that the user is to perform a connection with the first electronic device 201 and may provide the user with a screen as shown in FIG. 8(b). FIG. 8(b) is a view illustrating an example screen for providing the user with a state of being connected when “Connect” is selected. The third electronic device 203 may perform connection with the first electronic device 201 while the screen is displayed as shown in FIG. 8(b). According to an embodiment, the third electronic device 203 may provide a user interface based on at least one of text, an image, audio, video, or multimedia. According to an embodiment, the user interface providable by the third electronic device 203 may be, or may not be, displayed on the display, and may, or may not, output audio.

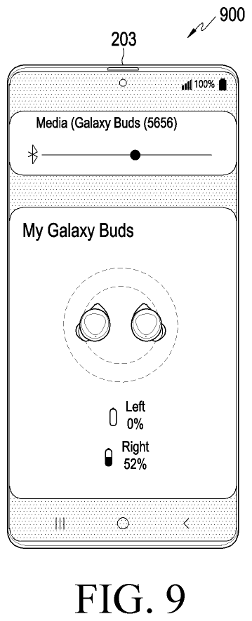

FIG. 9 is a view 900 illustrating another example of a user interface provided by a third electronic device 203 according to an embodiment.

According to an embodiment, upon receiving an advertising signal, the third electronic device 203 may output various user interfaces based on the information included in the advertising signal. For example, the third electronic device 203 may display, on the display, as the information included in the advertising signal, at least one of identification information about the first electronic device 201, the user's account information, information regarding whether the first electronic device 201 is currently paired with another device, a list of devices previously paired with the first electronic device 201, information regarding devices simultaneously pairable with the first electronic device 201, transmit power of the first electronic device 201, information regarding the detection area of the first electronic device 201, or information regarding the remaining battery of the first electronic device 201.

FIG. 9 illustrates an example user interface for providing remaining battery information about the first electronic device 201. According to an embodiment, only the remaining battery information about the first electronic device 201 may be displayed on the display. However, the remaining battery information about the second electronic device 202 configured in pair with the first electronic device 201 may also be displayed on the display.

According to an embodiment, since the advertising signal is transmitted by the first electronic device 201, the remaining battery information (e.g., 52%) about the first electronic device 201 may be displayed on the display, but the remaining battery information about the second electronic device 202, which is irrelevant to the advertising signal, may not be displayed or may be displayed as a set value (e.g., 0%). According to an embodiment, when the third electronic device 203 is able to obtain the remaining battery information about the second electronic device 202, the obtained remaining battery information about the second electronic device 202 may be displayed on the display.

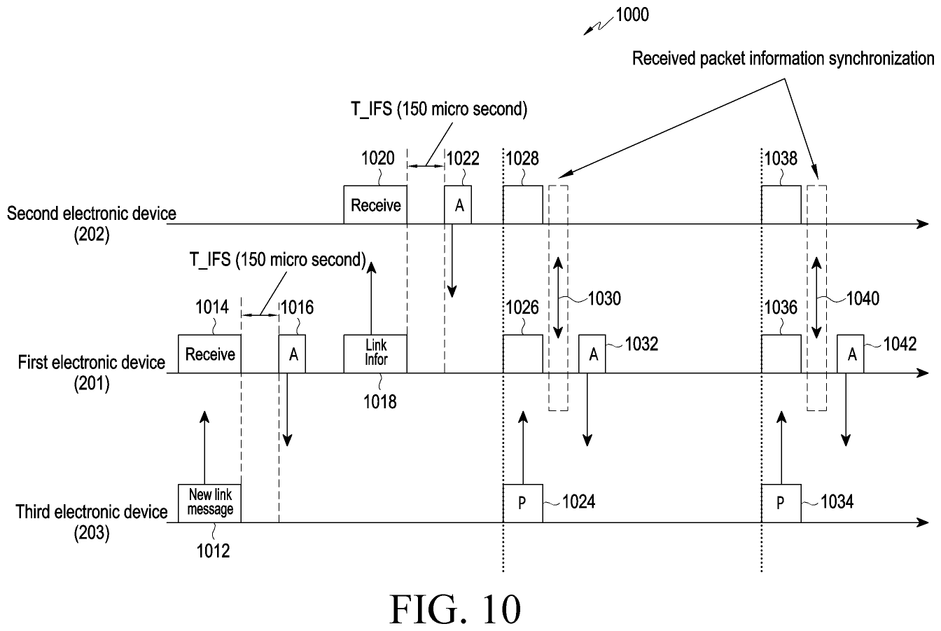

FIG. 10 is a signal 1000 flowchart illustrating an example response packet transmittance/reception operation according to an embodiment.

Referring to FIG. 10, the third electronic device 203 may transmit a link message to the first electronic device 201 through the first communication link 211 in operation 1012. For example, the link message may include an access address to be used for connection of the first communication link 211.

The first electronic device 201 may receive the link message from the third electronic device 203 in operation 1014. If a set time elapses after the time of reception of the link message, the first electronic device 201 may transmit an ACK packet indicating that the link message has been successfully received to the third electronic device 203 through the first communication link 211 in operation 1016. According to an embodiment, the set time may indicate the time interval between consecutive messages and/or packets (e.g., link message and ACK packet) of the same channel and be defined as an inter-frame space (T_IFS). For example, the set time may be 150 μs.

The first electronic device 201 may transmit information about the first communication link 211 to the second electronic device 202 in operation 1018 so that the second electronic device 202 may monitor the first communication link 211. The information about the first communication link 211 may be transmitted through the second communication link 212 established for communication between the first electronic device 201 and the second electronic device 202. According to an embodiment, before or after the first electronic device 201 connects the first communication link 211 with the third electronic device 203, the second communication link 212 may be connected between the first electronic device 201 and the second electronic device 202.

According to an embodiment, the information about the first communication link 211 may include an access address to be used for connection of the first communication link 211. According to an embodiment, the information about the first communication link 211 may further include at least one of device address information, LT address information, clock information, link key information, used channel map information, SDP information, supported feature information, or EIR information about the third electronic device 203.

The second electronic device 202 may receive the information about the first communication link 211 from the second electronic device 202 in operation 1020 and, if a set time (e.g., T_IFS set to 150 μs) elapses, transmit an ACK packet indicating that the information about the first communication link 211 has been successfully received to the first electronic device 201 in operation 1022.

If the first electronic device 201 and second electronic device 202 happen to be able to connect to the first communication link 211 through operations 1012 to 1022, a data packet and response packet transmission/reception operation may be performed. For example, the data packet and reception transmission/reception operation may include operations 1024 to 1042.

In operation 1024, the third electronic device 203 may transmit the first data packet to the first electronic device 201 through the first communication link 211. In operation 1026, the first electronic device 201 may receive a first data packet from the third electronic device 203 through the first communication link 211.

According to an embodiment, the second electronic device 202 may monitor the first communication link 211 based on the connection information about the first communication link 211 transferred from the first electronic device 201. For example, the second electronic device 202 may synchronize the clocks and/or timings used by the first electronic device 201 and the third electronic device 203, perform channel hopping through hopping channel operation and, based thereupon, monitor the first communication link 211. The second electronic device 202 may or may not receive the first data packet in operation 1028 by monitoring the first communication link 211.

According to an embodiment, in operation 1030, the first electronic device 201 and the second electronic device 202 may perform a received packet information synchronization operation for the first data packet. For example, the received packet information synchronization operation for the first data packet may include an operation in which the first electronic device 201 determines whether the first electronic device 201 has successfully received the first data packet and whether the second electronic device 202 has successfully received the first data packet.

According to an embodiment, the first electronic device 201 may receive, from the second electronic device 202, the identification information about the first data packet and the response information indicating whether the second electronic device 202 has successfully received the first data packet and determine whether the second electronic device 202 has successfully received the first data packet based on the received identification information and response information.

For example, when the identification information received from the second electronic device 202 corresponds to the identification information of the first data packet received by the first electronic device 201, and the response information received from the second electronic device 202 indicates that the second electronic device 202 has received the first data packet, the first electronic device 201 may determine that the second electronic device 202 has successfully received the first data packet.

According to an embodiment, upon determining that both the first electronic device 201 and second electronic device 202 have successfully received the first data packet, the first electronic device 201 may transmit an ACK packet to the third electronic device 203 in operation 1032.

According to an embodiment, upon determining that at least one of the first electronic device 201 and second electronic device 202 fails to successfully receive the first data packet, the first electronic device 201 may transmit a NACK packet to the third electronic device 203. According to an embodiment, the at least one of the first electronic device 201 and second electronic device 202 may be the device which has never received the first data packet before the time of failing to successfully receive the first data packet.

According to an embodiment, upon determining that one of the first electronic device 201 and second electronic device 202 successfully receives the first data packet, and the other of the first electronic device 201 and second electronic device 202 fails to successfully receive the first data packet, the first electronic device 201 may determine whether the other device has successfully received the first data packet at least once before the time of failing to successfully receive the first data packet). If the other device has successfully received the first data packet at least once before the time of failing to successfully receive the first data packet, the first electronic device 201 may consider that the other device has also successfully received the first data packet and may transmit an ACK packet to the third electronic device 203.

According to an embodiment, upon receiving the NACK packet for the first data packet from the first electronic device 201, the third electronic device 203 may retransmit the first data packet through the first communication link 211 to the first electronic device 201. In this case, operations 1024 to 1032 may be reperformed.

According to an embodiment, upon receiving the ACK packet for the first data packet from the first electronic device 201, the third electronic device 203 may transmit a second data packet, which is the next packet of the first data packet, through the first communication link 211 to the first electronic device 201 in operation 1034. In operation 1036, the first electronic device 201 may receive the second data packet from the third electronic device 203 through the first communication link 211.

According to an embodiment, the second electronic device 202 may receive, or may not receive, the second data packet in operation 1038 by monitoring the first communication link 211 based on the connection information about the first communication link 211 transferred from the first electronic device 201.

According to an embodiment, in operation 1040, the first electronic device 201 and the second electronic device 202 may perform a received packet information synchronization operation for the second data packet. For example, the received packet information synchronization operation for the second data packet may include an operation in which the first electronic device 201 determines whether the first electronic device 201 has successfully received the second data packet and whether the second electronic device 202 has successfully received the second data packet.

According to an embodiment, the first electronic device 201 may receive, from the second electronic device 202, the identification information about the second data packet and the response information indicating whether the second electronic device 202 has successfully received the second data packet and determine whether the second electronic device 202 has successfully received the second data packet based on the received identification information and response information.

For example, when the identification information received from the second electronic device 202 corresponds to the identification information of the second data packet received by the first electronic device 201, and the response information received from the second electronic device 202 indicates that the second electronic device 202 has received the second data packet, the first electronic device 201 may determine that the second electronic device 202 has successfully received the second data packet.

According to an embodiment, upon determining that the first electronic device 201 and second electronic device 202 have successfully received the second data packet, the first electronic device 201 may transmit an ACK packet to the third electronic device 203 in operation 1042.

According to an embodiment, upon determining that at least one of the first electronic device 201 and second electronic device 202 fails to successfully receive the second data packet, the first electronic device 201 may transmit a NACK packet to the third electronic device 203. According to an embodiment, the at least one of the first electronic device 201 and second electronic device 202 may be the device which has never received the second data packet before the time of failing to successfully receive the second data packet.

According to an embodiment, upon determining that one of the first electronic device 201 and second electronic device 202 successfully receives the second data packet, and the other of the first electronic device 201 and second electronic device 202 fails to successfully receive the second data packet, the first electronic device 201 may determine whether the other device has successfully received the second data packet at least once before the time of failing to successfully receive the second data packet. If the other device has successfully received the second data packet at least once before the time of failing to successfully receive the second data packet, the first electronic device 201 may consider that the other device has also successfully received the second data packet and may transmit an ACK packet to the third electronic device 203.

According to an embodiment, upon receiving the NACK packet for the second data packet from the first electronic device 201, the third electronic device 203 may retransmit the second data packet through the first communication link 211 to the first electronic device 201. In this case, operations 1034 to 1042 may be reperformed.

According to an embodiment, upon receiving the ACK packet for the second data packet from the first electronic device 201, the third electronic device 203 may transmit a third data packet, which is the next packet of the second data packet, through the first communication link 211 to the first electronic device 201. In this case, operations similar to operations 1024 to 1032 or operations 1034 to 1042 may be performed on the third data packet.

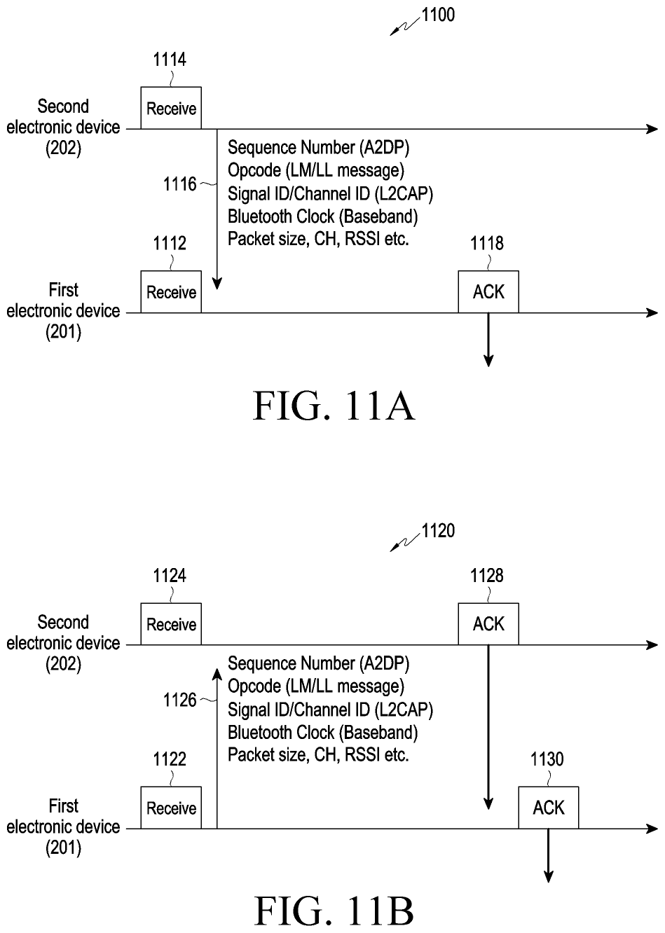

FIG. 11A is a flowchart 1100 illustrating an example of an operation for transmitting an ACK packet based on information about a packet received by a first electronic device 201 according to an embodiment.

According to an embodiment, operations 1112 to 1118 of FIG. 11A may be performed similarly to operations 1026 to 1032 or 1036 to 1042 of FIG. 10.

Referring to FIG. 11A, the first electronic device 201 may perform a synchronization operation for sharing information about a received packet with the second electronic device 202. According to an embodiment, the synchronization operation may include an operation for sharing information about the packet received by the first electronic device 201 and the second electronic device 202 (e.g., identification information about the received data packet) to identify whether the first electronic device 201 and second electronic device 202 each have successfully received the data packet from the third electronic device 203 within a set time period. According to an embodiment, the time of completion of the synchronization operation may be until immediately before the first electronic device 201 transmits an ACK or NACK packet to the third electronic device 203. Alternatively, the time of completion of the synchronization operation may be a time of termination of a set time related to the third electronic device 203, e.g., a time for the synchronization operation determined by adjusting the T_IFS. According to an embodiment, the synchronization operation may include operations 1112 to 1118.

According to an embodiment, in operation 1112, the first electronic device 201 may successfully receive the data packet during a set time period and, in operation 1114, the second electronic device 202 may successfully receive the data packet during the set time period. In response to successfully receiving the data packet during the set time period, the second electronic device 202 may transmit information about the response packet to the first electronic device 201 in operation 1116.

For example, the information about the response packet may include response information indicating whether the second electronic device 202 has successfully received the data packet during the set time period and identification information about the data packet received by the second electronic device 202 during the set time period. The identification information about the data packet received by the second electronic device 202 may include the sequence number of the received data packet. Further, the identification information about the data packet received by the second electronic device 202 may further include at least one of the opcode obtainable through an LM or LL message, L2CAP information such as channel ID and/or signal ID, Bluetooth clock information, size information about the received data packet, received signal strength information about the received data packet such as RSSI, type information about the received data packet, or codec information.

According to an embodiment, the first electronic device 201 may receive information about the packet received from the second electronic device 202 (hereinafter, ‘received packet information’) and transmit a response packet indicating whether the received packet information has been successfully received to the second electronic device 202. For example, the first electronic device 201 may receive the received packet information and, upon identifying, without an error, information about the packet received by the second electronic device 202, transmit a response packet (e.g., ACK packet) indicating whether reception of the received packet information has succeeded to the second electronic device 202. Alternatively, when the information about the packet received by the second electronic device 202 cannot be identified due to an error in decoding, although the received packet information is received, the first electronic device 201 may transmit a response packet (e.g., NACK packet) indicating that reception of the received packet information has failed to the second electronic device 202. Alternatively, when the received packet information is not received within a set time, the first electronic device 201 may transmit a response packet indicating that reception of the received packet information has failed to the second electronic device 202.

According to an embodiment, upon receiving the response packet indicating that reception of the received packet information has failed from the first electronic device 201, the second electronic device 202 may retransmit the received packet information.

When successfully receiving the received packet information, the first electronic device 201 may determine whether the second electronic device 202 has successfully received the data packet during the set time period based on the received, received packet information. For example, the first electronic device 201 may determine whether the second electronic device 202 has successfully received the same data packet as the data packet received in operation 1112, based on the response information indicating whether the second electronic device 202 has successfully received the data packet during the set time period and the identification information about the data packet received by the second electronic device 202 during the set time period.

Upon determining that the second electronic device 202 has successfully received the same data packet as the data packet received in operation 1112, the first electronic device 201 may determine that the first electronic device 201 and second electronic device 202 bot have successfully received the same data packet during the set time period and may transmit an ACK packet to the third electronic device 203 in operation 1118.

FIG. 11B is a flowchart 1120 illustrating another example of an operation for transmitting an ACK packet based on information about a packet received by a first electronic device 201 according to an embodiment.

According to an embodiment, operations 1122 to 1130 of FIG. 11B may be performed similarly to operations 1026 to 1032 or 1036 to 1042 of FIG. 10.

Referring to FIG. 11B, the first electronic device 201 may perform a synchronization operation for sharing received packet information with the second electronic device 202. According to an embodiment, the synchronization operation may include an operation for sharing the received packet information by the first electronic device 201 and the second electronic device 202 to identify whether the first electronic device 201 and second electronic device 202 each have successfully received the data packet within a set time period. According to an embodiment of the present invention, The time of completion of the synchronization operation may be until immediately before the first electronic device 201 transmits an ACK or NACK packet to the third electronic device 203. Alternatively, the time of completion of the synchronization operation may be a time of termination of a set time related to the third electronic device 203, e.g., a time for the synchronization operation determined by adjusting the T_IFS. According to an embodiment, the synchronization operation may include operations 1122 to 1130.

According to an embodiment, in operation 1122, the first electronic device 201 may successfully receive the data packet during a set time period and, in operation 1124, the second electronic device 202 may successfully receive the data packet during the set time period. In response to successfully receiving the data packet during the set time period, the first electronic device 201 may transmit the received packet information to the second electronic device 202 in operation 1126.

For example, the received packet information may include response information indicating whether the first electronic device 201 has successfully received the data packet during the set time period and identification information about the data packet received by the first electronic device 201 during the set time period. The identification information about the data packet received by the first electronic device 201 may include the sequence number of the data packet received during the set time period. Further, the identification information about the data packet received by the first electronic device 201 may further include at least one of the opcode obtainable through an LM or LL message, L2CAP information such as channel ID and/or signal ID, Bluetooth clock information, size information about the received data packet, received signal strength information about the received data packet such as RSSI, type information about the received data packet, or codec information.

According to an embodiment, the second electronic device 202 may receive the received packet information from the first electronic device 201 and may identify the data packet successfully received by the first electronic device 201 within the set time period based on the receive received packet information. For example, the second electronic device 202 may identify the data packet successfully received by the first electronic device 201 within the set time period based on the response information indicating whether the first electronic device 201 has successfully received the data packet during the set time period and the identification information about the data packet received during the set time period by the first electronic device 201.

According to an embodiment, when the data packet successfully received by the first electronic device 201 during the set time period is identical to the data packet received in operation 1124, the second electronic device 202 may transmit an ACK packet to the first electronic device 201 in operation 1128.

Upon receiving the ACK packet from the second electronic device 202, the first electronic device 201 may determine that the second electronic device 202 has successfully received the same data packet as the data packet received in operation 1122. Accordingly, the first electronic device 201 may determine that the first electronic device 201 and second electronic device 202 both have successfully received the same data packet within the set time period and may transmit an ACK packet to the third electronic device 203 in operation 1130.

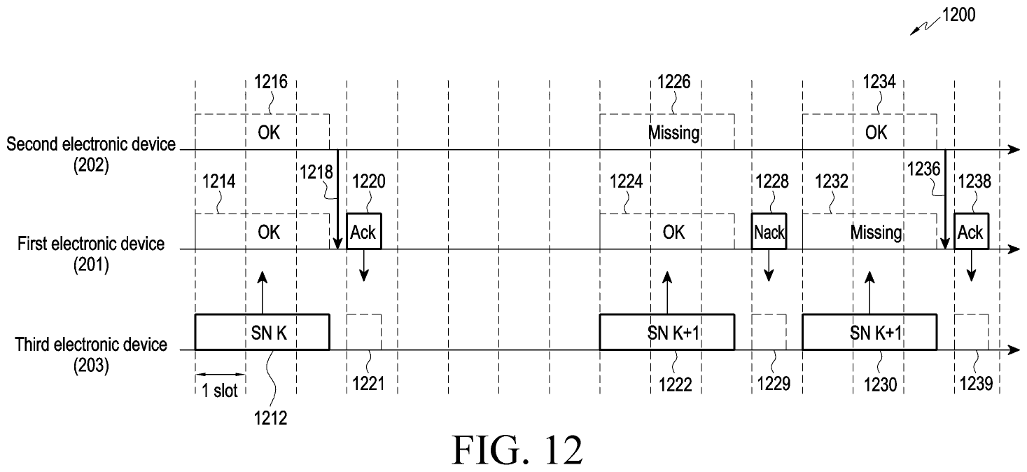

FIG. 12 is a signal flowchart 1200 illustrating an example of an operation for transmitting/receiving a response packet considering a previously received data packet according to an embodiment.

Referring to FIG. 12, in operation 1212, the third electronic device 203 may transmit a first data packet having sequence number K (hereinafter, referred to as ‘SN K packet’) to the first electronic device 201 through the first communication link 211. In operation 1214, the first electronic device 201 may receive the SN K packet from the third electronic device 203 through the first communication link 211.

According to an embodiment, the second electronic device 202 may receive information about the first communication link 211 from the first electronic device 201 through the second communication link 212 and monitor the first communication link 211 based on the received information. The second electronic device 202 may monitor the first communication link 211, thereby receiving the SN K packet in operation 1216.

According to an embodiment, in operation 1218, the second electronic device 202 may transmit, to the first electronic device 201 through the second communication link 212, identification information about the SN K packet and response information indicating whether the second electronic device 202 has successfully received the SN K packet. The first electronic device 201 may receive the identification information and response information from the second electronic device 202 and determine whether the second electronic device 202 has successfully received the SN K packet based on the received identification information and response information.

For example, when the identification information received from the second electronic device 202 corresponds to the identification information of the SN K packet received by the first electronic device 201, and the response information received from the second electronic device 202 indicates that the second electronic device 202 has received the SN K packet, the first electronic device 201 may determine that the second electronic device 202 has successfully received the SN K packet.

According to an embodiment, upon determining that the first electronic device 201 and second electronic device 202 have successfully received the SN K packet, the first electronic device 201 may transmit an ACK packet for the SN K packet to the third electronic device 203 in operation 1220.

According to an embodiment, in operation 1221, the third electronic device 203 may receive the ACK packet for the SN K packet from the first electronic device 201. According to an embodiment, upon receiving the ACK packet for the SN K packet from the first electronic device 201, the third electronic device 203 may transmit, to the first electronic device 201 through the first communication link 211, a second data packet having sequence number K+1 (hereinafter, referred to as ‘SN K+1 packet’), as the next packet of the SN K packet. In operation 1224, the first electronic device 201 may receive the SN K+1 packet from the third electronic device 203 through the first communication link 211.

According to an embodiment, the second electronic device 202 may monitor the first communication link 211 based on the connection information about the first communication link 211 transferred from the first electronic device 201. Although monitoring the first communication link 211, the second electronic device 202 may fail to receive the SN K+1 packet due to a physical obstacle or ambient channel environment in operation 1226.

According to an embodiment, upon failing to receive identification information about the SN K+1 packet from the second electronic device 202 within a set time after receiving the SN K+1 packet, the first electronic device 201 may determine that the second electronic device 202 has failed to receive the SN K+1 packet. The first electronic device 201 may transmit a NACK packet to the third electronic device 203 based on determining that the second electronic device 202 has failed to receive the SN K+1 packet in operation 1228.

According to an embodiment, in operation 1229, the third electronic device 203 may receive the NACK packet for the SN K+1 packet from the first electronic device 201. According to an embodiment, upon receiving the NACK packet for the SN K+1 packet from the first electronic device 201, the third electronic device 203 may retransmit the SN K+1 packet through the first communication link 211 in operation 1230.

According to an embodiment, in operation 1232, the first electronic device 201 may fail to receive the retransmitted SN K+1 packet and, in operation 1234, the second electronic device 202 may receive the retransmitted SN K+1 packet. In operation 1236, the second electronic device 202 may transmit, to the first electronic device 201, identification information about the retransmitted SN K+1 packet and response information indicating whether the second electronic device 202 has successfully received the retransmitted SN K+1 packet. The first electronic device 201 may determine whether the second electronic device 202 has successfully received the retransmitted SN K+1 packet based on the identification information and response information received from the second electronic device 202.

For example, when the identification information received from the second electronic device 202 corresponds to the identification information of the SN K+1 packet received by the first electronic device 201, and the response information received from the second electronic device 202 indicates that the second electronic device 202 has received the retransmitted SN K+1 packet, the first electronic device 201 may determine that the second electronic device 202 has successfully received the SN K+1 packet.

According to an embodiment, the first electronic device 201 may determine that the first electronic device 201 has successfully received the SN K+1 packet, considering that the first electronic device 201 failed to receive the retransmitted SN K+1 packet but has received the first transmitted SN K+1 packet. For example, the first electronic device 201 may determine that the first electronic device 201 and second electronic device 202 both have successfully received the SN K+1 packet, considering that the first electronic device 201 has received the SN K+1 packet first transmitted in operation 1224, and the second electronic device 202 has received the retransmitted SN K+1 packet. Accordingly, the first electronic device 201 may transmit an ACK packet for the SN K+1 packet to the third electronic device 203 in operation 1238.

As described above, if the first electronic device 201 or the second electronic device 202 has a history of having received the second data packet before the set time period although both the first electronic device 201 and second electronic device 202 has not received the second data packet (e.g., the SN K+1 packet) transmitted during the set time period, the second data packet may be regarded as having been received.

According to an embodiment, in operation 1239, the third electronic device 203 may receive the ACK packet for the SN K+1 packet from the first electronic device 201. According to an embodiment, upon receiving the ACK packet for the SN K+1 packet from the first electronic device 201, the third electronic device 203 may later transmit an SN K+2 packet through the first communication link 211.

According to an embodiment, a method by a first electronic device (e.g., the electronic device 102 or electronic device 104 of FIG. 1 and the first electronic device 201 of FIG. 2) may comprise sharing information about a received packet with a second electronic device (e.g., the electronic device 102 or electronic device 104 of FIG. 1 and the second electronic device 202 of FIG. 2) to obtain first information indicating whether the first electronic device and the second electronic device each receive a data packet from a third electronic device (e.g., the electronic device 101 of FIG. 1 and the third electronic device 203 of FIG. 2) during a first time period (e.g., operation 502 of FIG. 5A),

According to an embodiment, the method may further comprise, upon identifying that the first electronic device and the second electronic device each fail to receive the data packet during the first time period based on the first information, transmitting a response packet indicating a negative acknowledgment (NACK) to the third electronic device (e.g., operation 504 of FIG. 5A).

According to an embodiment, the method may further comprise sharing the information about the received packet with the second electronic device to obtain second information indicating whether the first electronic device and the second electronic device each receive the data packet retransmitted from the third electronic device during a second time period after the first time period (e.g., operation 506 of FIG. 5A).

According to an embodiment, the method may further comprise identifying whether the first electronic device and the second electronic device each receive the data packet at least one time during the first time period and the second time period based on the first information and the second information and transmitting a response packet indicating the NACK or an acknowledgment (ACK) based on a result of the identification to the third electronic device (e.g., operation 508 of FIG. 5A).

According to an embodiment, the method may further comprise, upon identifying that the first electronic device and the second electronic device each receive the data packet during the first time period, transmitting the response packet indicating the ACK to the third electronic device.

According to an embodiment, transmitting the response packet indicating the NACK or ACK to the third electronic device may include, upon identifying that the first electronic device and the second electronic device each receive the data packet at least one time during the first time period and the second time period, transmitting the response packet indicating the ACK to the third electronic device.

According to an embodiment, transmitting the response packet indicating the NACK or ACK to the third electronic device may include, upon identifying that the first electronic device and the second electronic device each fail to receive the data packet at least one time during the first time period and the second time period, transmitting the response packet indicating the NACK to the third electronic device.

According to an embodiment, transmitting the response packet indicating the NACK or ACK to the third electronic device may include, upon identifying that the first electronic device and the second electronic device each fail to receive the data packet at least one time during the first time period and the second time period, transmitting the response packet indicating the NACK to the third electronic device (e.g., operation 510 of FIG. 5B), sharing the information about the received packet with the second electronic device to obtain third information indicating whether the first electronic device and the second electronic device each receive the data packet retransmitted from the third electronic device during a third time period after the second time period (e.g., operation 512 of FIG. 5B), and upon identifying that the first electronic device and the second electronic device each receive the data packet during the third time period based on the third information, transmitting the response packet indicating the ACK to the third electronic device (e.g., operation 514 of FIG. 5B).

According to an embodiment, obtaining the first information may include, upon receiving the data packet from the third electronic device during the first time period, detecting information about the data packet, identifying whether the second electronic device received the data packet from the third electronic device during the first time period, based on whether information corresponding to the detected information is received from the second electronic device, and obtaining the first information based on receiving the data packet from the third electronic device during the first time period and identifying whether the second electronic device receives the data packet from the third electronic device during the first time period.

According to an embodiment, obtaining the first information may include, upon receiving the data packet from the third electronic device during the first time period by the first electronic device, detecting information about the data packet, transmitting the detected information to the second electronic device, identifying whether the second electronic device receives the data packet from the third electronic device during the first time period, based on whether a response signal to the transmitted information is received from the second electronic device, and obtaining the first information based on receiving the data packet from the third electronic device by the first electronic device during the first time period and identifying whether the second electronic device receives the data packet from the third electronic device during the first time period.

According to an embodiment, obtaining the second information may include, upon receiving the data packet from the third electronic device during the second time period, detecting information about the data packet, identifying whether the second electronic device receive the data packet from the third electronic device during the second time period, based on whether information corresponding to the detected information is received from the second electronic device, and obtaining the second information based on receiving the data packet from the third electronic device during the second time period and identifying whether the second electronic device receives the data packet from the third electronic device during the second time period.

According to an embodiment, obtaining the second information may include, upon receiving the data packet from the third electronic device during the second time period, detecting information about the data packet, transmitting the detected information to the second electronic device, identifying whether the second electronic device received the data packet from the third electronic device during the second time period, based on whether a response signal to the transmitted information is received from the second electronic device, and obtaining the second information based on receiving the data packet from the third electronic device by the first electronic device during the second time period and identifying whether the second electronic device received the data packet from the third electronic device during the second time period.

According to an embodiment, information about the received data packet shared with the second electronic device may include at least one of sequence number information about the data packet received from the third electronic device, operation code (opcode) information about the data packet received from the third electronic device, type information about the data packet received from the third electronic device, size information about the data packet received from the third electronic device, clock information about a time of receiving the data packet from the third electronic device, codec information related to the data packet received from the third electronic device, channel profile information related to the data packet received from the third electronic device, or received signal strength information about the data packet received from the third electronic device.

According to an embodiment, history information about whether electronic devices receive data packets during a set time period may be identified based on information about received data packets shared between electronic devices.

According to an embodiment, it is possible to efficiently use link operation resources between electronic devices and to prevent unnecessary resource waste by transmitting a response packet based on history information.

The electronic device according to an embodiment of the disclosure may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 1640) including one or more instructions that are stored in a storage medium (e.g., internal memory 1636 or external memory 1638) that is readable by a machine (e.g., the electronic device 1601). For example, a processor (e.g., the processor 1620) of the machine (e.g., the electronic device 1601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. A first electronic device comprising:
a memory;
a communication module configured to perform communication with a second electronic device and a third electronic device; and
at least one processor operatively connected with the memory and the communication module,
wherein the memory stores instructions configured to, when executed, cause the first electronic device to:
share information about a received packet with the second electronic device to obtain first information indicating whether the first electronic device and the second electronic device each receive a data packet from the third electronic device during a first time period,
in case that the first information indicates that the first electronic device and the second electronic device each fail to receive the data packet during the first time period, transmit a first response packet indicating a negative acknowledgment (NACK) to the third electronic device,
share the information about the received packet with the second electronic device to obtain second information indicating whether the first electronic device and the second electronic device each receive the data packet retransmitted from the third electronic device during a second time period after the first time period,
identify whether the first electronic device and the second electronic device each receive the data packet at least one time during the first time period and the second time period based on the first information and the second information, and
transmit a second response packet indicating NACK or an acknowledgment (ACK) based on a result of the identification to the third electronic device.

2. The first electronic device of claim 1, wherein the instructions are configured to, when executed, cause the first electronic device to, in case that the first information indicates that the first electronic device and the second electronic device each receive the data packet during the first time period, transmit the first response packet indicating ACK to the third electronic device.

3. The first electronic device of claim 1, wherein the instructions are configured to, when executed, cause the first electronic device to, upon identifying that the first electronic device and the second electronic device each receive the data packet at least one time during the first time period and the second time period, transmit the second response packet indicating the ACK to the third electronic device.

4. The first electronic device of claim 1, wherein the instructions are configured to, when executed, cause the first electronic device to, upon identifying that the first electronic device and the second electronic device each fail to receive the data packet at least one time during the first time period and the second time period, transmit the second response packet indicating the NACK to the third electronic device.

5. The first electronic device of claim 1, wherein the instructions are configured to, when executed, cause the first electronic device to,
upon identifying that the first electronic device and the second electronic device each fail to receive the data packet at least one time during the first time period and the second time period, transmit the second response packet indicating the NACK to the third electronic device,
share the information about the received packet with the second electronic device to obtain third information indicating whether the first electronic device and the second electronic device each receive the data packet retransmitted from the third electronic device during a third time period after the second time period, and
upon identifying that the first electronic device and the second electronic device each receive the data packet during the third time period based on the third information, transmit a third response packet indicating ACK to the third electronic device.

6. The first electronic device of claim 1, wherein the instructions are configured to, when executed, cause the first electronic device to,
in case that the first information indicates that the first electronic device and the second electronic device each receive the data packet during the first time period, detect information about the data packet,
identify whether the second electronic device receives the data packet from the third electronic device during the first time period, based on whether information corresponding to the detected information is received from the second electronic device, and
obtain the first information based on receiving the data packet from the third electronic device during the first time period and identifying whether the second electronic device receives the data packet from the third electronic device during the first time period.

7. The first electronic device of claim 1, wherein the instructions are configured to, when executed, cause the first electronic device to,
in case that the first information indicates that the first electronic device and the second electronic device each receive the data packet during the first time period, detect information about the data packet,
transmit the detected information to the second electronic device,
identify whether the second electronic device receives the data packet from the third electronic device during the first time period, based on whether a response signal to the transmitted information is received from the second electronic device, and
obtain the first information based on receiving the data packet from the third electronic device during the first time period and identifying whether the second electronic device receives the data packet from the third electronic device during the first time period.

8. The first electronic device of claim 1, wherein the instructions are configured to, when executed, cause the first electronic device to,
upon receiving the data packet from the third electronic device during the second time period, detect information about the data packet,
identify whether the second electronic device received the data packet from the third electronic device during the second time period, based on whether information corresponding to the detected information is received from the second electronic device, and
obtain the second information based on receiving the data packet from the third electronic device during the second time period and identifying whether the second electronic device receives the data packet from the third electronic device during the second time period.

9. The first electronic device of claim 1, wherein the instructions are configured to, when executed, cause the first electronic device to,
upon receiving the data packet from the third electronic device during the third time period, detect information about the data packet,
transmit the detected information to the second electronic device,
identify whether the second electronic device receives the data packet from the third electronic device during the second time period, based on whether a response signal to the transmitted information is received from the second electronic device, and
obtain the second information based on receiving the data packet from the third electronic device during the second time period and identifying whether the second electronic device receives the data packet from the third electronic device during the second time period.

10. The first electronic device of claim 1, wherein information about the received packet shared with the second electronic device includes at least one of sequence number information about the data packet received from the third electronic device, operation code (opcode) information about the data packet received from the third electronic device, type information about the data packet received from the third electronic device, size information about the data packet received from the third electronic device, clock information about a time of receiving the data packet from the third electronic device, codec information related to the data packet received from the third electronic device, channel profile information related to the data packet received from the third electronic device, or received signal strength information about the data packet received from the third electronic device.

11. A method by a first electronic device, the method comprising:
sharing information about a received packet with a second electronic device to obtain first information indicating whether the first electronic device and the second electronic device each receive a data packet from a third electronic device during a first time period;
in case that the first information indicates that the first electronic device and the second electronic device each fail to receive the data packet during the first time period, transmitting a first response packet indicating a negative acknowledgment (NACK) to the third electronic device;
sharing the information about the received packet with the second electronic device to obtain second information indicating whether the first electronic device and the second electronic device each receive the data packet retransmitted from the third electronic device during a second time period after the first time period;
identifying whether the first electronic device and the second electronic device each receive the data packet at least one time during the first time period and the second time period based on the first information and the second information; and
transmitting a second response packet indicating NACK or an acknowledgment (ACK) based on a result of the identification to the third electronic device.

12. The method of claim 11, further comprising, in case that the first information indicates that the first electronic device and the second electronic device each receive the data packet during the first time period, transmitting the first response packet indicating ACK to the third electronic device.

13. The method of claim 11, wherein transmitting the response packet indicating the NACK or ACK to the third electronic device includes, upon identifying that the first electronic device and the second electronic device each receive the data packet at least one time during the first time period and the second time period, transmitting the second response packet indicating the ACK to the third electronic device.

14. The method of claim 11, wherein transmitting the response packet indicating the NACK or ACK to the third electronic device includes, upon identifying that the first electronic device and the second electronic device each fail to receive the data packet at least one time during the first time period and the second time period, transmitting the second response packet indicating the NACK to the third electronic device.

15. The method of claim 11, wherein transmitting the response packet indicating the NACK or ACK to the third electronic device includes,
upon identifying that the first electronic device and the second electronic device each fail to receive the data packet at least one time during the first time period and the second time period, transmitting the second response packet indicating the NACK to the third electronic device;
sharing the information about the received packet with the second electronic device to obtain third information indicating whether the first electronic device and the second electronic device each receive the data packet retransmitted from the third electronic device during a third time period after the second time period; and
upon identifying that the first electronic device and the second electronic device each receive the data packet during the third time period based on the third information, transmitting a response packet indicating ACK to the third electronic device.

16. The method of claim 11, wherein obtaining the first information includes,
in case that the first information indicates that the first electronic device and the second electronic device each receive the data packet during the first time period, detecting information about the data packet;
identifying whether the second electronic device receive the data packet from the third electronic device during the first time period, based on whether information corresponding to the detected information is received from the second electronic device; and
obtaining the first information based on receiving the data packet from the third electronic device during the first time period and identifying whether the second electronic device receives the data packet from the third electronic device during the first time period.

17. The method of claim 11, wherein obtaining the first information includes,
in case that the first information indicates that the first electronic device and the second electronic device each receive the data packet during the first time period, detecting information about the data packet;
transmitting the detected information to the second electronic device;
identifying whether the second electronic device receives the data packet from the third electronic device during the first time period, based on whether a response signal to the transmitted information is received from the second electronic device; and
obtaining the first information based on receiving the data packet from the third electronic device by the first electronic device during the first time period and identifying whether the second electronic device receives the data packet from the third electronic device during the first time period.

18. The method of claim 11, wherein obtaining the second information includes,
upon receiving the data packet from the third electronic device during the second time period, detecting information about the data packet;
identifying whether the second electronic device receive the data packet from the third electronic device during the second time period, based on whether information corresponding to the detected information is received from the second electronic device; and
obtaining the second information based on receiving the data packet from the third electronic device during the second time period and identifying whether the second electronic device receives the data packet from the third electronic device during the second time period.

19. The method of claim 11, wherein obtaining the second information includes,
upon receiving the data packet from the third electronic device during the second time period, detecting information about the data packet;
transmitting the detected information to the second electronic device;
identifying whether the second electronic device receives the data packet from the third electronic device during the second time period, based on whether a response signal to the transmitted information is received from the second electronic device; and
obtaining the second information based on receiving the data packet from the third electronic device by the first electronic device during the second time period and identifying whether the second electronic device receives the data packet from the third electronic device during the second time period.

20. The method of claim 11, wherein information about the received data packet shared with the second electronic device includes at least one of sequence number information about the data packet received from the third electronic device, operation code (opcode) information about the data packet received from the third electronic device, type information about the data packet received from the third electronic device, size information about the data packet received from the third electronic device, clock information about a time of receiving the data packet from the third electronic device, codec information related to the data packet received from the third electronic device, channel profile information related to the data packet received from the third electronic device, or received signal strength information about the data packet received from the third electronic device.
